(19) United States
(12) Patent Application Publication
(10) Pub. No.: US 2015/0156519 A1
(43) Pub. Date: Jun. 4, 2015

(54) PLAYING DEVICE, PLAYING METHOD, DELIVERY DEVICE, DELIVERY METHOD, DELIVERY PROGRAM, PLAYING PROGRAM, RECORDING MEDIUM, AND METADATA

(71) Applicant: Sharp Kabushiki Kaisha, Osaka-shi, Osaka (JP)

(72) Inventors: Shuichi Watanabe, Osaka-shi (JP); Yasuaki Tokumo, Osaka-shi (JP); Takuya Iwanami, Osaka-shi (JP)

(21) Appl. No.: 14/412,228

(22) PCT Filed: Jul. 4, 2013
(86) PCT No.: PCT/JP2013/068333

§ 371 Date: Dec. 31, 2014

(30) Foreign Application Priority Data
Jul. 10, 2012 (JP) 2012-155075
Oct. 9, 2012 (JP) 2012-224170
Jan. 15, 2013 (JP) 2013-004291
Apr. 16, 2013 (JP) 2013-085389

(51) Int. Cl. H04N 21/2343; H04N 21/435; H04N 21/235; H04N 9/82; H04N 5/77

(52) U.S. Cl. CPC H04N 21/2343; H04N 9/8205; H04N 5/772; H04N 21/235; H04N 21/435

(57) ABSTRACT

A playing device (200) includes a segment conversion unit (240) that converts a plurality of segments having a short time length and forming a live broadcast program into a fewer number of segments with a long time length for recording and playing and records the fewer number of segments in a storage unit (250) and a control information conversion unit (230) that converts control information including each piece of playing information of the plurality of segments into control information including each piece of playing information of the fewer number of segments. Thus, content can be appropriately processed for recording and playing.

### TECHNICAL FIELD

The present invention relates to a playing device, a playing method, and a playing program playing content. Further, the present invention relates to a delivery device, a delivery method, and a delivery program delivering content. Furthermore, the present invention relates to a recording medium recording the playing program and the delivery program and metadata necessary to play content.

### BACKGROUND ART

In recent years, as a demand for the Internet rapidly increases, users watching moving-image content have increased.

In light of such a circumstance, various technologies for delivering moving-image content in a streaming manner have been developed. Dynamic Adaptive Streaming over HTTP (DASH) of Moving Picture Experts Group (MPEG) can be exemplified as one of the technologies.

In the DASH, two formats of Media Presentation Description (MPD) data and a media segment presented as a MPEG-2 TS stream or an MP4 file in the MPD data are defined. The media segment is a transmission unit of HTTP transmission in which moving-image content is divided in a time division manner. The MPD data is streaming delivery control metadata and includes information for a request of a media segment to a server or information indicating whether moving-image content is lively delivered content (live content) or VOD content.

A delivery device delivers a plurality of media segments to a playing device while lively delivering a video captured by a live camera, but may not be, of course, configured to deliver the media segments in response to a request of the playing device, until generation of the media segments is completed. Further, it takes some time to transmit the media segments from the delivery device to the playing device.

Accordingly, for example, a time length of the media segment is 5 seconds, the delivery device can deliver the initial media segment after 5 seconds after photographing starts with a live camera. Therefore, the playing device lively normally plays a video captured before 5 or more seconds by the live camera.

In order to suppress such a time lag problem, the time length of each media segment included in lively delivered content is determined to be short.

### SUMMARY OF INVENTION

### Technical Problem

Incidentally, the playing device records content on video record during live delivery and plays the recorded content after the live delivery ends in some cases.

The delivery device records content during live delivery in the delivery device or a secondary delivery device, and then delivers the recorded content in a VOD manner after end of the live delivery in some cases.

From the viewpoint of the above-mentioned time lag problem, when the number of media segments included in live content is large, a total sum of data of header portions of all media segments is greater than when the number of media segments is small. Further, when the number of media segments (that is, the number of files) increases, “a size on a disc occupied by content” easily increases more than when the number of media segments is small. Therefore, when data of live content is directly used as VOD content in which the time lag problem is rarely problematic or data of recorded content as in the related art, there is a problem that a large storage space is unnecessarily occupied.

In the case of HTTP delivery by MPD data, when the number of media segments is large, an issuing frequency of messages for a request for the media segments increases. Therefore, there is a problem that a processing load on generation or transmission and reception of request messages and response messages increases.

The present invention is devised in light of the foregoing problems and a main object of the present invention is to realize a delivery device capable of appropriately processing content for VOD delivery or recording and playing and a playing device capable of appropriately recording content for recording and playing.

### Solution to Problem

According to an aspect of the present invention, in order to resolve the foregoing problems, there is provided a playing device that records and plays content delivered by being divided into a plurality of pieces of time-divided data in a time division manner. The playing device includes: acquisition means for acquiring first metadata in which playing information regarding each piece of time-divided data included in the plurality of pieces of time-divided data is indicated; first conversion means for converting all or some of the plurality of pieces of time-divided data into a different number of pieces of time-divided data; second conversion means for converting the first metadata into second metadata in which playing information regarding each piece of time-divided data included in the different number of time-divided data is indicated; and playing means for directly playing the plurality of pieces of delivered time-divided data based on the first metadata, and recording and playing the different number of time-divided data based on the second metadata. Here, the first metadata may be included in the content or may be data separate from the content. When a header portion is provided in each of the plurality of pieces of time-divided data, the first metadata may be partially delivered to be included in the header portions. That is, the playing information regarding the time-divided data may be included in the header portion of each piece of time-divided data.

In the foregoing configuration, the playing device according to the aspect of the present invention can shorten the length of the time-divided data (increases the number of pieces of time-divided data) when the length of the time-divided data is too long. The playing device can enlarge the length of the time-divided data when the length of the time-divided data is too short. Here, as the case in which the length of the time-divided data is too long, for example, a case in which the size of the time-divided data per file is too large and the file of the time-divided data is fragmented to be recorded can be exemplified. In this case, playing efficiency of the time-divided data may deteriorate at the time of playing. On the other hand, as the case in which the length of the time-divided data is too short, for example, a case in which the number of pieces of time-divided data (the number of files) is too large, it takes too much time to seek for each file, and thus the playing efficiency deteriorates can be exemplified.

Accordingly, it is possible to obtain the advantageous effect in which the playing device according to the aspect of the present invention can appropriately record the content for recording and playing (without deterioration in the playing efficiency at the time of playing).

According to another aspect of the present invention, in order to resolve the foregoing problems, there is provided a playing method of a playing device that records and plays content delivered by being divided into a plurality of pieces of time-divided data in a time division manner. The playing method includes: an acquisition step of acquiring first metadata in which playing information regarding each piece of time-divided data included in the plurality of pieces of time-divided data is indicated; a first conversion step of converting all or some of the plurality of pieces of time-divided data into a different number of pieces of time-divided data; a second conversion step of converting the first metadata into second metadata in which playing information regarding each piece of time-divided data included in the different number of time-divided data is indicated; and a playing step of directly playing the plurality of pieces of delivered time-divided data based on the first metadata, and recording and playing the different number of time-divided data based on the second metadata.

In the foregoing configuration, in the playing method according to the aspect of the present invention, it is possible to obtain the same operational advantageous effects as the playing device according to the aspect of the present invention.

According to still another aspect of the present invention, in order to resolve the foregoing problems, there is provided a delivery device including first conversion means for converting a plurality of pieces of time-divided data divided from content in a time division manner into a different number of pieces of time-divided data; first delivery means for delivering first metadata in which playing information regarding each of the plurality of pieces of time-divided data is indicated and delivering the plurality of pieces of time-divided data; second conversion means for converting the first metadata into second metadata in which playing information regarding each piece of time-divided data included in the different number of pieces of time-divided data is indicated; and second delivery means for delivering the second metadata and delivering the different number of pieces of time-divided data.

In the foregoing configuration, in the delivery device according to the aspect of the present invention, the plurality of pieces of time-divided data is converted into a different number of pieces (fewer or larger number) of time-divided data.

When the plurality of pieces of time-divided data are converted into a fewer number of pieces of time-divided data, there are the following advantages.

The plurality of pieces of time-divided data are converted into a fewer number of pieces of time-divided data forming the number of pieces of time-divided data less than the number of pieces of time-divided data forming the plurality of pieces of time-divided data. Accordingly, when the data structure of the time-divided data is set as a data structure including header information with a predetermined header length, a total data amount of the fewer number of pieces of time-divided data is less than a total data amount of the plurality of pieces of time-divided data. Further, the total data amount is determined depending on a kind of file system. A size on a recording medium occupied by the fewer number of pieces of time-divided data is normally less than a size on a recording medium occupied by the plurality of pieces of time-divided data irrespective of the data structure of the time-divided data.

Accordingly, the delivery device according to the aspect of the present invention can record the content for recording and playing more efficiently.

Conversely, when the plurality of pieces of time-divided data are converted into the larger number of pieces of time-divided data, there are the following advantages. When the plurality of pieces of time-divided data are converted into the larger number of pieces of time-divided data, the length of each piece of time-divided data after the conversion becomes shorter. Accordingly, a time lag decreases in which the delivery device receives a request for the playing of the content from the playing and delivers the first time-divided data to the playing device.

Accordingly, the delivery device according to the aspect of the present invention can deliver the content in a VOD manner with less delay.

As described above, it is possible to obtain the advantageous effect in which the delivery device according to the aspect of the present invention can appropriately process the content for VOD delivery or recording and playing.

According to further still another aspect of the present invention, in order to resolve the foregoing problems, there is provided a delivery device that records and delivers content delivered by being divided into a plurality of pieces of time-divided data in a time division manner. The delivery device includes: acquisition means for acquiring first metadata in which playing information regarding each piece of time-divided data included in the plurality of pieces of time-divided data is indicated; first conversion means for converting all or some of the plurality of pieces of time-divided data into a different number of pieces of time-divided data; second conversion means for converting the first metadata into second metadata in which playing information regarding each piece of time-divided data included in the different number of pieces of time-divided data is indicated; and delivery means for delivering the second metadata, and recording and delivering the different number of pieces of time-divided data.

In the foregoing configuration, it is possible to obtain the advantageous effect in which the delivery device according to the aspect of the present invention can appropriately process the content for VOD delivery or recording and playing.

According to further still another aspect of the present invention, in order to resolve the foregoing problems, there is provided a delivery method including: a first conversion step of converting a plurality of pieces of time-divided data divided from content in a time division manner into a different number of pieces of time-divided data; a first delivery step of delivering first metadata in which playing information regarding each of the plurality of pieces of time-divided data is indicated and delivering the plurality of pieces of time-divided data; a second conversion step of converting the first metadata into second metadata in which playing information regarding each piece of time-divided data included in the different number of pieces of time-divided data is indicated; and a second delivery step of delivering the second metadata and delivering the different number of pieces of time-divided data.

In the foregoing configuration, in the delivery method according to the aspect of the present invention, it is possible to obtain the same operational effects as the delivery device according to the aspect of the present invention.

In the playing device according to the aspect of the present invention, the content may be content which is divided into the plurality of pieces of time-divided data in the time division manner to be lively delivered. The playing means may lively play the plurality of pieces of time-divided data based on the first metadata.

In the foregoing configuration, it is possible to obtain the advantageous effect in which the playing device according to the aspect of the present invention can appropriately record the lively delivered content for the recording and playing.

In the playing device according to the aspect of the present invention, the first conversion means may convert all or some of the plurality of pieces of time-divided data into a fewer number of pieces of time-divided data.

In the foregoing configuration, the playing device according to the aspect of the present invention records and plays the fewer number of pieces of time-divided data based on the second metadata in which the playing information used to play the fewer number of pieces of time-divided data is indicated.

In the foregoing configuration, the playing device according to the aspect of the present invention converts all or some of the plurality of pieces of time-divided data into the fewer number of pieces of time-divided data forming all or some of the plurality of pieces of time-divided data into the fewer number of pieces of time-divided data forming the number of pieces of time-divided data less than the number of pieces of time-divided data forming the plurality of pieces of time-divided data. Accordingly, when the data structure of the time-divided data is set as a data structure including header information with a predetermined header length, a total data amount of the fewer number of pieces of time-divided data is less than a total data amount of all or some of the plurality of pieces of time-divided data. Further, the total data amount is determined depending on a kind of file system. When a size on a recording medium occupied by the fewer number of pieces of time-divided data is normally less than a size on a recording medium occupied by the plurality of pieces of time-divided data irrespective of the data structure of the time-divided data.

As described above, it is possible to obtain the advantageous effect in which the playing device according to the aspect of the present invention can record the content lively delivered (lively delivered or lively broadcasted through communication) for the recording and playing efficiently (that is, further suppressing consumption of a vacant capacity).

In the playing device according to the aspect of the present invention, the first conversion means may convert the plurality of pieces of time-divided data into the fewer number of pieces of time-divided data by classifying all or some of the plurality of pieces of time-divided data into groups and integrating a time-divided data aggregate of the group in each group.

In the playing device according to the aspect of the present invention, the first conversion means may classify all or some of the plurality of pieces of time-divided data into a given number of groups.

The given number may be a number for which a starting position of each piece of time-divided data included in the fewer number of pieces of time-divided data is a random access point.

In the foregoing configuration, it is possible to obtain the advantageous effect in which the playing device according to the aspect of the present invention can start recording and playing any time-divided data among the fewer number of pieces of time-divided data.

In the playing device according to the aspect of the present invention, a first time length which is a time length of each piece of time-divided data included in all or some of the plurality of pieces of time-divided data and a second time length which is a time length of each piece of time-divided data included in the fewer number of pieces of time-divided data and is an integer multiple of the first time length may be indicated in the first metadata. The given number may be implicitly indicated in the first metadata by the first time length and the second time length.

In the playing device according to the aspect of the present invention, the given number may be explicitly indicated in the first metadata.

In the playing device according to the aspect of the present invention, in the first metadata, specific information may be indicated to specify some of the plurality of pieces of time-divided data. The first conversion means may convert some of the specified plurality of pieces of time-divided data based on the specific information into the fewer number of pieces of time-divided data.

In the playing device according to the aspect of the present invention, the specific information may be an identifier of starting time-divided data in a chronological order of some of the plurality of pieces of time-divided data. The playing information of each piece of time-divided data included in the plurality of pieces of time-divided data may include the identifier of the time-divided data.

In the playing device according to the aspect of the present invention, the identifier indicated in the first metadata may be the identifier of the starting time-divided data which is not delivered at a timing at which the acquisition means acquires the first metadata.

In the foregoing configuration, when the playing device according to the aspect of the present invention starts live playing during the live delivery of the content, the playing device converts the first metadata into the second metadata not including the playing information regarding the time-divided data which has not yet been delivered (that is, which may not be acquired by the playing device).

It is also possible to obtain the advantageous effect in which the playing device according to the aspect of the present invention can record and play the content without executing an unnecessary process of recording and playing the time-divided data which may not be acquired.

According to an aspect of the present invention, there is provided a program causing a computer to operate as a playing device or a delivery device and causing the computer to function as each of the means of the playing device or the delivery device. A computer-readable recording medium recording the program is also included in the scope of the present invention.

A metadata regarding content lively delivered by being divided into a plurality of pieces of time-divided data in a time division manner is also included in the scope of the present invention. In the metadata, integration information for classifying all or some of the plurality of pieces of time-divided data into a given number of groups and integrating a time-divided data aggregate of the group in each group is indicated. Playing information regarding each piece of time-divided data included in all or some of the plurality of pieces of time-divided data is indicated.

### Advantageous Effects of Invention

As described above, in the playing device according to the present invention, it is possible to obtain the advantageous effect in which content can be appropriately recorded for recording and playing.

In the delivery device according to the present invention, it is possible to obtain the advantageous effect in which content can be appropriately processed for VOD delivery or recording and playing.

### BRIEF DESCRIPTION OF DRAWINGS

FIG. 1 is a diagram illustrating the configurations of main units of a delivery system according to an embodiment of the present invention.

FIG. 2 is a diagram illustrating an example of metadata handled in the delivery system in FIG. 1.

FIG. 3 is a diagram schematically illustrating a media segment aggregate for live delivery before integration and a media segment for recording and playing after the integration in the delivery system in FIG. 1.

FIG. 4 is a flowchart illustrating an operation of the delivery system in FIG. 1.

FIG. 5 is a diagram illustrating an example of metadata handled in a delivery system according to a modification example of the delivery system in FIG. 1.

FIG. 6 is a diagram illustrating an example of metadata handled in a delivery system according to a modification example of the delivery system in FIG. 1.

FIG. 7 is a diagram illustrating an example of metadata handled in a delivery system according to a modification example of the delivery system in FIG. 1.

FIG. 8 is a diagram illustrating an example of metadata handled in a delivery system according to a modification example of the delivery system in FIG. 1.

FIG. 9 is a diagram illustrating the configurations of main units of a delivery system according to another embodiment of the present invention.

FIG. 10 is a diagram illustrating the configurations of main units of a delivery system according to still another embodiment of the present invention.

FIG. 11 is a diagram schematically exemplifying a media segment aggregate for live delivery before integration and a media segment for recording and playing after the integration in the delivery system in FIG. 10.

FIG. 12 is a diagram schematically exemplifying a media segment aggregate for live delivery before integration and a media segment for recording and playing after the integration in a delivery system according to a modification example of the delivery system in FIG. 10.

FIG. 13 is a diagram schematically exemplifying a media segment aggregate for live delivery before integration and a media segment for recording and playing after the integration in a delivery system according to a modification example of the delivery system in FIG. 10.

FIG. 14 is a diagram schematically exemplifying a media segment aggregate for live delivery before integration and a media segment for recording and playing after the integration in a delivery system according to a modification example of the delivery system in FIG. 10.

FIG. 15 is a diagram schematically exemplifying a media segment aggregate for live delivery before integration and a media segment for recording and playing after the integration in a delivery system according to a modification example of the delivery system in FIG. 10.

FIG. 16 is a diagram illustrating an example of metadata handled in the delivery system in FIG. 10.

FIG. 17 is a diagram illustrating random access points (RAPs) in a media segment aggregate for live delivery before integration and the RAPs in media segments for recording and playing after the integration.

FIG. 18 is a diagram schematically illustrating media segment aggregates for one or both of live delivery and recording playing which are preserved in a storage unit at a given time.

FIG. 19 is a diagram schematically illustrating the details of data structures of media segment aggregates for live delivery before integration and a media segment for recording and playing after the integration.

FIG. 20 is a diagram illustrating the configurations of main units of a delivery system according to further still another embodiment of the present invention.

FIG. 21 is a diagram illustrating an example of control information including an identifier indicating whether the media segment has description for announcement of execution of an integration process (whether the integration process can be executed by the description) for each delivery period or a media segment described in the control information.

FIG. 22 is a diagram illustrating an example of the metadata box included in the media segment.

FIG. 23 is a diagram illustrating another example of the metadata box included in the media segment.

FIG. 24 is a diagram illustrating an example of the control information including an identifier indicating whether the media segment has the description for the announcement of execution of the integration process and an identifier indicating whether non-execution of the process is permitted.

FIG. 25 is a diagram illustrating an example of a metadata box included in the media segment when difference control information is used.

### DESCRIPTION OF EMBODIMENTS

### First Embodiment

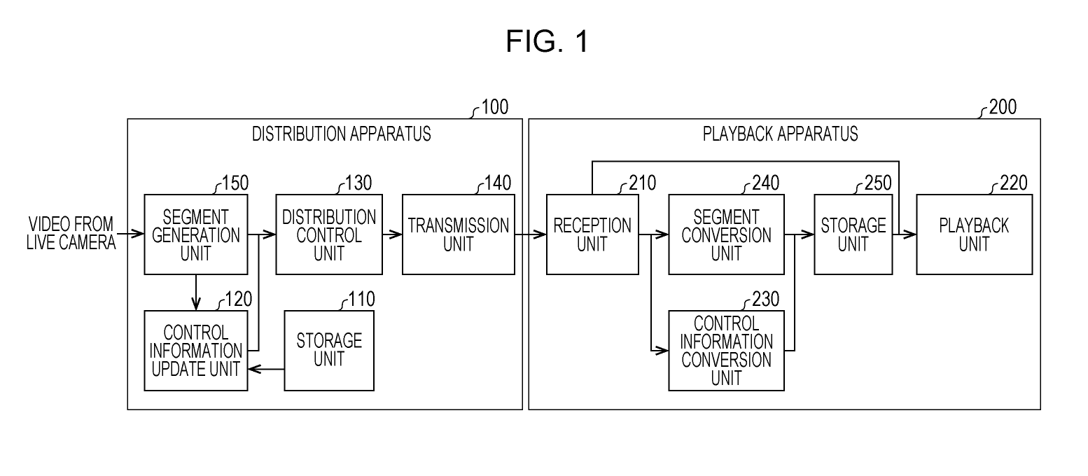

A delivery system according to an embodiment of the present invention will be described below with reference to FIGS. 1 to 8.

In the delivery system according to the embodiment, a delivery device lively delivers a program video of a live camera through communication and a playing device lively plays the delivered program video. The program video includes a plurality of media segments and each media segment is obtained through time-division of the program video.

In the embodiment, the playing device records a program video during live playing in an efficient recording scheme. Specifically, when a given number of media segments for live delivery is received, the given number of media segments is integrated into a single media segment to be recorded. Accordingly, the recorded program video can be played after the live delivery without unnecessarily waste of a storage capacity of the playing device.

In the embodiment, a program video is acquired, control information necessary to play the program video is delivered to the playing device by the delivery device, and the program video is acquired based on the delivered control information and is played by the playing device. The present invention can be applied to various standards or operational technologies. When the present invention is applied to MPEG Media Transport (MMT) which is a transmission standard defined by the MPEG, composition information (CI) defined in the MMT corresponds to the control information. When the present invention is applied to MPEG's Dynamic Adaptive Streaming over HTTP (MPEG-DASH), Media Presentation Data (MPD) defined in the MPEG-DASH corresponds to the control information.

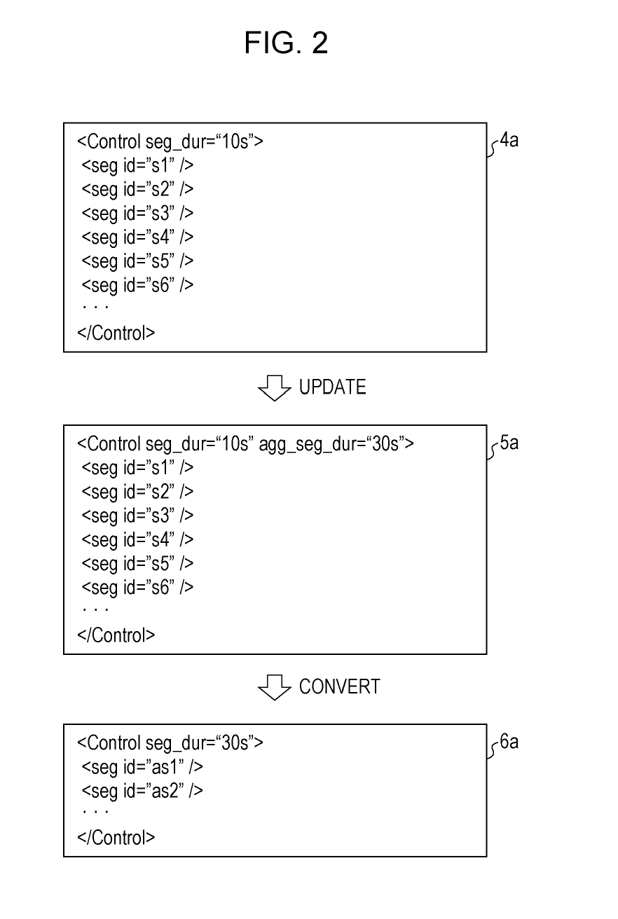

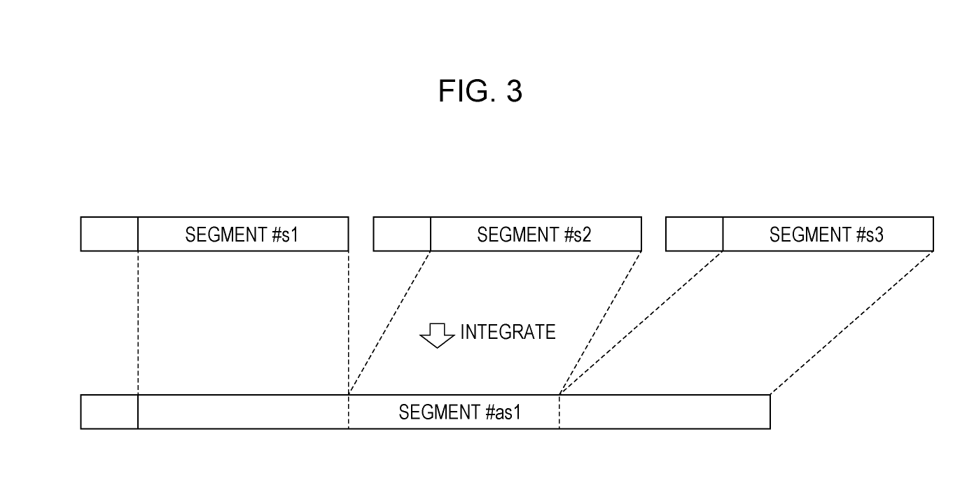

Hereinafter, the configurations of main units of the delivery system according to the embodiment will be described with reference to FIGS. 1 to 3. FIG. 1 is a diagram illustrating the configurations of the main units of a delivery device and a playing device included in the delivery system according to the embodiment. FIG. 2 is a diagram schematically illustrating control information handled in the delivery system according to the embodiment. FIG. 3 is a diagram schematically illustrating a media segment aggregate for live delivery before integration and a media segment for recording and playing after the integration.

As illustrated in FIG. 1, the delivery system according to the embodiment includes a delivery device 100 and a playing device 200.

### (Delivery Device 100)

As illustrated in FIG. 1, the delivery device 100 includes a storage unit 110, a control information update unit 120, a delivery control unit 130, a transmission unit 140, and a segment generation unit 150.

### (Storage Unit 110)

The storage unit 110 is a recording medium that can reserve data. The storage unit 110 reserves control information used for live delivery of a program video.

### (Segment Generation Unit 150)

The segment generation unit 150 completes generation of media segments including only a video within a given period as video information during input of the video from a live camera, when the given period has passed, and then starts generating subsequent media segments.

In the control information used for the live delivery and preserved in the storage unit 110, an acquisition destination of the media segments sequentially generated by the segment generation unit 150 and an acquisition timing are registered in advance.

### (Control Information Update Unit 120)

The control information update unit 120 reads the control information from the storage unit 110 and updates the control information by adding segment conversion information used to convert a media segment aggregate for live delivery into a media segment for recording and playing to the control information.

For example, the control information update unit 120 updates control information 4a to control information 5a by adding an agg_seg_dur attribute indicating a time length (30 seconds) of the converted media segment to the control information 4a in FIG. 2 read from the storage unit 110.

### (Delivery Control Unit 130)

The delivery control unit 130 delivers the control information to which the segment conversion information is added via the transmission unit 140. Since the acquisition destination of the media segments sequentially generated by the segment generation unit 150 and the acquisition timing are registered in the control information, the playing device makes a request for the media segments using such information registered in the control information. The delivery control unit 130 sets the media segment such that the media segment can be delivered whenever the media segment for live delivery is supplied, and then delivers the media segment via the transmission unit 140 in response to the request from the playing device.

### (Transmission Unit 140)

The transmission unit 140 loads the media segments and the control information on a communication line to transmit the media segments and the control information.

### (Playing Device 200)

As illustrated in FIG. 1, the playing device 200 includes a reception unit 210, a playing unit 220, a control information conversion unit 230, a segment conversion unit 240, and a storage unit 250.

### (Reception Unit 210)

The reception unit 210 is a tuner that receives a program video and the like (specifically, the control information for acquisition and playing of a program video and the media segment aggregate included in the program video) via a communication line.

### (Playing Unit 220)

The playing unit 220 plays the acquired program video based on the control information. Specifically, the playing unit 220 lively plays the acquired program video based on the control information used for live delivery of the program video, and records and plays the recorded program video based on the control information used for recording and playing of the program video.

### (Control Information Conversion Unit 230)

The control information conversion unit 230 converts the control information for live delivery (which corresponds to “first metadata” in the claims) including the segment conversion information into control information for recording and playing (which corresponds to “second metadata” in the claims) and records the control information for recording and playing in the storage unit 250.

For example, as illustrated in FIGS. 2 and 3, the control information conversion unit 230 converts 3 seg components (which correspond to “playing information” in the claims) regarding 3 (=30 seconds/10 seconds) media segments (#s1 to #s3) into seg components of a single media segment (#as1) after integration based on a seg_dur attribute indicating a time length (10 seconds) of the media segment for live delivery and an agg_seg_dur attribute indicating a time length (30 seconds) of the media segment for recording and playing, which are included in the control information 5a in FIG. 2. The same also applies to media segments with an id after “s4.” The control information conversion unit 230 substitutes the original value (10 seconds) of the seg_dur attribute with a value (30 seconds) registered in the agg_seg_dur attribute and deletes the agg_seg_dur attribute. As a result, the control information conversion unit 230 updates the control information 5a in FIG. 2 to the control information 6a.

### (Segment Conversion Unit 240)

The segment conversion unit 240 converts a given number of media segments into a single media segment based on the control information for live delivery including segment conversion information (which corresponds to information indicating a “given number” in the claims and “integration information” in the claims), when the given number of media segments for live delivery (which corresponds to “time-divided data” in the claims) is supplied.

For example, the segment conversion unit 240 integrates 3 media segments into a single media segment for recording and playing based on the seg_dur attribute and the agg_seg_dur attribute included in the control information 5a in FIG. 2, when 3 (=30 seconds/10 seconds) media segments for live delivery are supplied.

The segment conversion unit 240 records the converted single media segment in the storage unit 250 in association with the control information used for playing of the program video including the media segments as constituent components.

### (Storage Unit 250)

The storage unit 250 is a recording medium (a hard disk in the embodiment) that can reserve data. After the live delivery of the program video, the control information for recording and playing of the program video and the media segment aggregate for recording and playing included in the program video are preserved in the storage unit 250.

The configurations of the delivery device 100 and the playing device 200 included in the delivery system according to the embodiment have been described roughly above.

### (Operation of Delivery System)

Next, an operation of the delivery system according to the embodiment will be described below with reference to FIGS. 2 to 4. The control information is assumed to be preserved to deliver and play the program video of a program (hereinafter also referred to as a “target program”) executing live delivery hereinafter in the storage unit 110 of the delivery device 100.

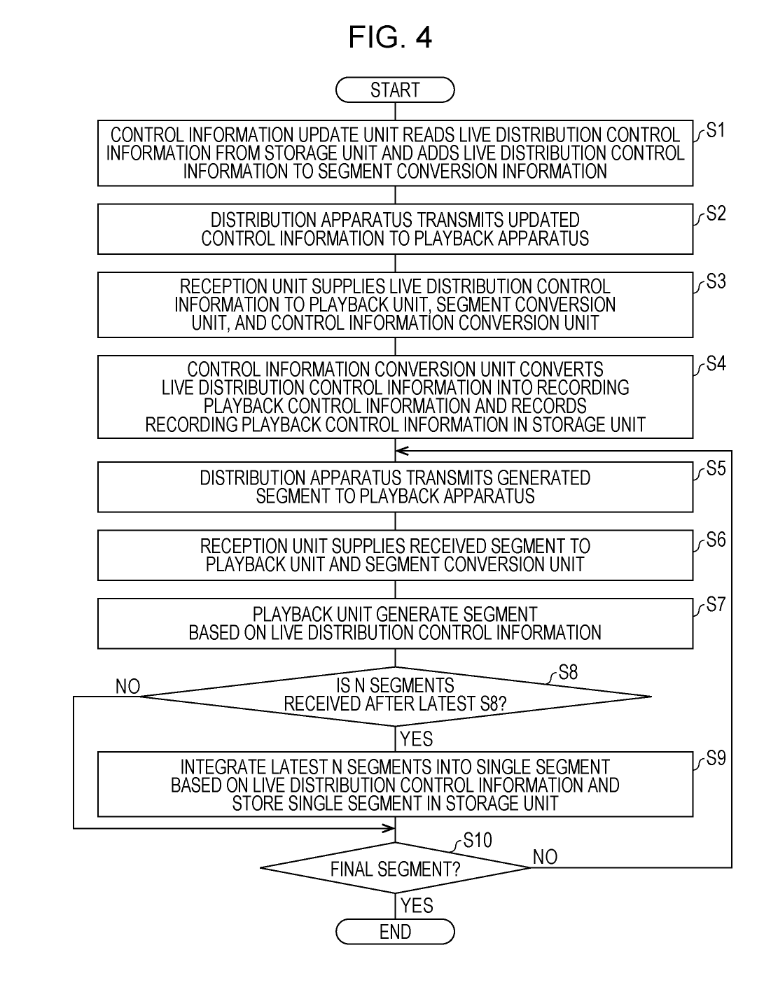

FIG. 4 is a flowchart illustrating an operation of the delivery system according to the embodiment from start of live delivery of the program video of the target program to completion of live playing.

As illustrated in FIG. 4, first, the control information update unit 120 reads control information for live delivery from the storage unit 110, adds the segment conversion information (S1), and supplies the updated control information to the delivery control unit 130.

Next, the control information update unit 120 delivers the updated control information via the transmission unit 140 (S2).

The update (S1) of the control information and the delivery (S2) of the updated control information are executed before the start of the live delivery. When the start time of the live delivery arrives, the playing device 200 transmits a request for the media segments to the delivery device 100.

The reception unit 210 of the playing device 200 receiving the updated control information supplies the received control information to the playing unit 220, the control information conversion unit 230, and the segment conversion unit 240 (S3).

The control information conversion unit 230 receiving the control information converts the control information from the control information for live delivery into the control information for recording and playing and records the control information for recording and playing in the storage unit 250 (S4).

When the start time of the live delivery arrives, the segment generation unit 150 of the delivery device 100 starts generating the media segments. The start time of the live delivery can be interpreted as two cases, i.e., a case indicating a time at which generation of a live camera video to be delivered starts (a delivery start of the media segments is later than the time) and a case indicating a time at which the generation of the first media segment is completed and the media segment is delivered. Here, in the embodiment, the case of the former time is referred to as a “start time of the live delivery.”

Thereafter, when a given period passes from the execution of the process of the latest S5 (from the start time of the live delivery when the process of S5 is initially executed), the segment generation unit 150 of the delivery device 100 completes the generation of the media segments including only the video within the period as video information. Then, the delivery control unit 130 receiving the media segments delivers the media segments via the transmission unit 140 in response to a request from the playing device 200 (S5).

The reception unit 210 of the playing device 200 receiving the media segments supplies the received media segments to the playing unit 220 and the segment conversion unit 240 (S6).

The playing unit 220 lively plays the media segments received in S6 based on the control information for live delivery received in S3 (S7).

On the other hand, the segment conversion unit 240 determines whether N media segments (in the example of FIG. 2, N=3 (30 seconds/10 seconds) are received after the time point of the process of the latest step S8 (S8).

When the segment conversion unit 240 determines that the N media segments are not yet received after the time point of the process of the latest step S8, the segment conversion unit 240 records the media segments supplied in the latest S6 in the storage unit 250. Then, the delivery system allows the process to proceed to a process of step S10.

Conversely, when the segment conversion unit 240 determines that the N media segments are received after the time point of the process of the latest step S8, the segment conversion unit 240 integrates the media segment supplied in the latest S6 and the remaining N−1 media segments already recorded in the storage unit 250 into the single media segment for recording and playing based on the segment conversion information included in the control information for live delivery received in S3 (S9). On the basis of the example of FIGS. 2 and 3, the segment conversion unit 240 integrates 3 media segments (#s1 to #s3) into the single media segment (#as1). More specifically, in the case of i-th step S9, information indicating the media segment corresponding to an i-th seg component from the upper side in the control information for recording and playing indicates the integrated i-th single media segment, and then the 3 media segments are integrated into the single media segment. After the process of S9, the process proceeds to a process of S10.

In S10, the segment conversion unit 240 determines whether the determination process of S8 is executed on the final segment included in the video of the target program. When the segment conversion unit 240 determines that the determination process of S8 is not executed on the final segment, the delivery system allows the process to return to the process of S5.

Conversely, when the segment conversion unit 240 determines that the determination process of S8 is executed on the final segment, the delivery system ends the process.

The operation of the delivery system from the start of the live delivery to the completion of the live playing has been described above.

As understood from the above description, when the target program is a 60-minute program and the time length of the media segment for live delivery is 10 seconds, the delivery device delivers 360 media segments for live delivery. When the time length of the media segment for recording and playing is 30 seconds, 120 media segments for recording and playing are preserved in the storage unit 250 of the playing device 200 as the result of the foregoing operation. The control information for recording and playing used to sequentially play the 120 media segments for recording and playing are preserved in the storage unit 250.

When the playing device 200 is instructed to record and play the target program via an operation unit (not illustrated), the playing device 200 first reads the control information for recording and playing from the storage unit 250 and sequentially reads and plays the media segment aggregates for recording and playing based on the control information for recording and playing.

### (Advantages of Playing Device 200)

The above description can be summarized as follows.

That is, the playing device 200 plays the 60-minute program content divided into the 360 media segments in the time division manner and lively delivered based on the control information used for the playing of the program content.

The segment conversion unit 240 of the playing device 200 integrates the 360 media segments into the 120 media segments with triple the time length by classifying the 360 media segments into 3 groups and integrating 3 media segments of the respective groups.

The control information conversion unit 230 of the playing device 200 converts the playing information (an id or the like of the media segment) regarding each of the 360 media segments and the control information for live delivery in which the time lengths (each “10 seconds” and “30 seconds”) of the media segments before and after the integration are indicated into the control information in which the playing information regarding each of the 120 pieces of time-divided data for recording and playing is indicated.

The playing unit 220 of the playing device 200 lively plays the 360 media segments based on the control information for live delivery, and records and plays the 120 media segments based on the control information for recording and playing.

In the foregoing configuration, the 120 media segments for recording and playing with the time length of 30 seconds are preserved in the storage unit 250 of the playing device 200. In regard to this, a total data amount (the data amount of program video) of real data portions of the 120 media segments with the time length of 30 seconds is not different from a total data amount of real data portions of the 360 media segments with the time length of 10 seconds. On the other hand, when the header length of a header portion is fixed, a total data amount of the header portions of the 120 media segments is ⅓ of a total data amount of the header portions of the 360 media segments.

A “size on a disk” occupied by each file of the 120 media segments with the time length of 30 seconds is generally less than a “size on a disk” occupied by each file of the 360 media segments with the time length of 10 seconds.

Accordingly, it is possible to obtain the advantageous effect in which the playing device 200 can record the lively delivered program content for recording and playing more efficiently than in the related art.

### First Modification Example of Delivery System

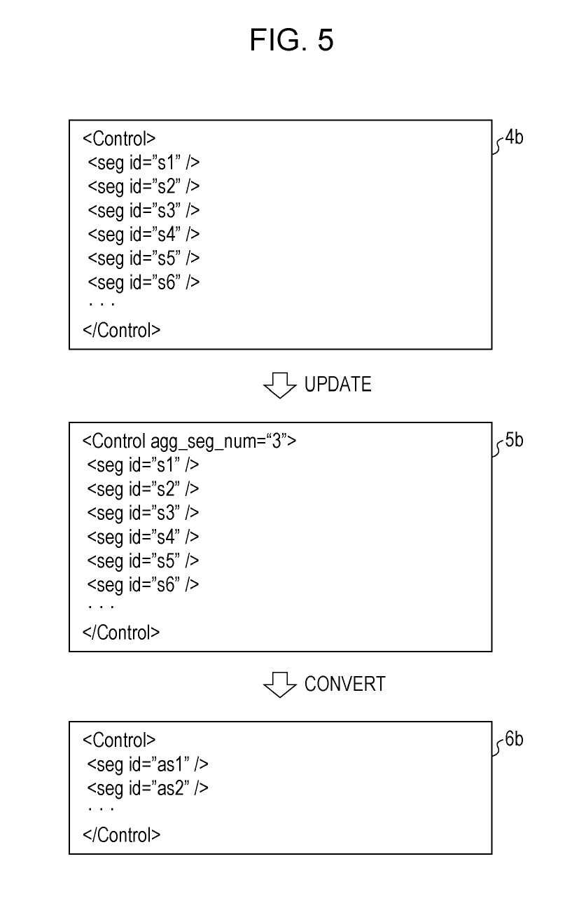

A first modification example of the delivery system according to the first embodiment will be described with reference to FIGS. 3 and 5. FIG. 5 is a diagram schematically illustrating control information handled in the delivery system according to the first modification example.

The delivery system according to the first modification example is different from the above-described delivery system in that operations of the control information update unit, the segment conversion unit, and the control information conversion unit are different.

That is, on the side of the delivery device, the control information update unit updates control information for live delivery of the storage unit 110 by assigning an agg_seg_num attribute indicating the number of media segments to be integrated into a single media segment. For example, the control information update unit updates control information 4b in FIG. 5 to control information 5b in FIG. 5.

On the side of the playing device, the control information conversion unit updates control information for live delivery to control information for recording and playing based on an attribute value of the agg_seg_num attribute included in the control information for live delivery. For example, as illustrated in FIGS. 3 and 5, the control information conversion unit converts 3 seg components regarding 3 media segments (#s1 to #s3) into a seg component of an integrated single media segment (#as1) based on the attribute value of the agg_seg_num attribute. The same also applies to media segments with an id after “s4.” The control information conversion unit deletes the agg_seg_num attribute. As a result, the control information conversion unit 230 converts the control information 5b in FIG. 5 to the control information 6b.

When the same number of media segments for live delivery is supplied to the attribute value of the agg_seg_num attribute, the segment conversion unit integrates the media segments into the single media segment for recording and playing based on the attribute value of the agg_seg_num attribute included in the supplied control information. For example, the segment conversion unit integrates the 3 media segments (#s1 to #s3) in FIG. 3 into the single media segment (#as1) in FIG. 3 based on the attribute value “3” of the agg_seg_num attribute included in the control information 5b in FIG. 5.

### Second Modification Example of Delivery System

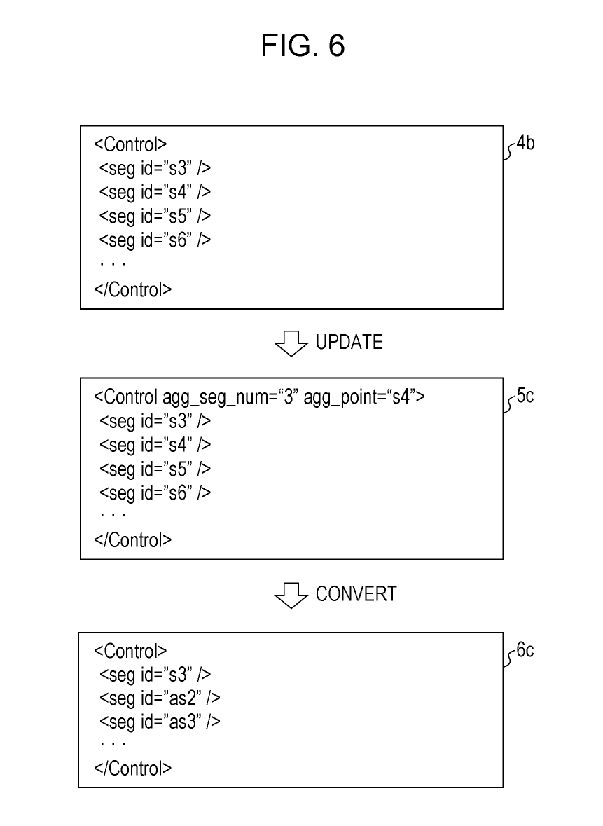

A second modification example of the delivery system according to the first embodiment will be described with reference to FIG. 6. FIG. 6 is a diagram schematically illustrating control information handled in the delivery system according to the second modification example.

The delivery system according to the second modification example is different from the delivery system according to the first modification example in that operations of the control information update unit, the delivery control unit, the reception unit, the segment conversion unit, and the control information conversion unit are different.

That is, on the side of the delivery device, the control information update unit updates control information for live delivery of the storage unit 110 by assigning an agg_point attribute (which corresponds to “specific information” and an “identifier” in the claims) with an attribute value of the value of an id of the starting segment of a media segment group which can be integrated into a single media segment present immediately after a media segment (that is, a starting media segment not yet delivered at a timing of a process of the control information update unit) currently generated by the segment generation unit 150 in addition to the agg_seg_num attribute indicating the number of media segments to be integrated into a single media segment. When the currently generated media segment is the starting media segment of the media segment group which can be integrated into the single media segment, the value of the id is used. For example, the control information update unit updates control information 4b in FIG. 6 to control information 5c in FIG. 6.

In this example, a playing device is assumed to newly participate halfway in a live delivery service in which delivery has already started and the playing device is assumed to start reception of the live delivery halfway. Since the playing device can participate in the live delivery service at any timing, a segment corresponding to a starting seg component of the control information may not be said to be the starting segment of the media segment group which can be integrated into the single media segment in the control information including only the seg components of the media segments delivered after the participation time. Therefore, when the delivery device receives a live delivery request from the new playing device, the delivery device executes the update process on the control information of the storage unit 110. That is, the control information is converted into the control information including only the seg components of the media segments delivered after the participation time and information indicating the starting segment of the media segment group which can be integrated into the single media segment is added. The delivery control unit transmits the control information updated by the control information update unit to the newly participating playing device via the transmission unit 140.

On the side of the playing device, the reception unit receives the control information and supplies the control information to the playing unit 220, the control information conversion unit, and the segment conversion unit. Then, the control information conversion unit updates the control information for live delivery to the control information for recording and playing based on the attribute values of the agg_seg_num attribute and the agg_point attribute included in the supplied control information for live delivery. Specifically, a media segment aggregate including the media segments to which the id with the same value as the attribute value of the agg_point attribute is assigned and the subsequent media segments are divided into two groups that each have the same number as the attribute value of the agg_seg_num attribute. Then, in each group, a seg component aggregate regarding all of the media segments of each group is converted into a seg component of the single media segment. FIG. 6 illustrates an example in which the playing device participates in the delivery from the time at which the media segment with the id of “s3” is generated and starts the live delivery. For example, as illustrated in FIG. 6, the control information conversion unit converts 3 seg components regarding 3 media segments (#s4 to #s6) into a seg component of an integrated single media segment (#as2) based on an attribute value “3” of the agg_seg_num attribute and an attribute value “s4” of the agg_point attribute. The same also applies to media segments with an id after “s7.” The control information conversion unit deletes the agg_seg_num attribute and the agg_point attribute from the control information. As a result, the control information conversion unit 230 converts the control information 5c in FIG. 6 to control information 6c.

When the media segments of the same number as the attribute value of the agg_seg_num attribute are received, the segment conversion unit integrates these media segments into the single media segment for recording and playing based on the attribute values of the agg_seg_num attribute and the agg_point attribute included in the supplied control information for live delivery. For example, based on the attribute value “3” of the agg_seg_num attribute and the attribute value “s4” of the agg_point attribute included in the control information 5c in FIG. 6, the 3 media segments (#s4 to #s6) are integrated into the single media segment (#as2) in FIG. 3.

In the modification example, even in a case in which the playing device starts receiving a program during live delivery of the program, the playing device can integrate a given number of media segments into the single media segment when the playing device receives these media segments. The control information for recording and playing generated in this case by the playing device includes only information regarding the media segments (subsequent to “s3” in the example of FIG. 6) from the reception start time point and does not include information regarding the media segments (previous to “s3” in the example of FIG. 6) already delivered at the time point at which the playing device starts receiving the program. Accordingly, when the playing device according to the modification example records and plays the video, the playing device can be said to have the advantage of playing the video from the reception start time point using the unintegrated media segment “s3” stored in the storage unit 110 and the integrated media segments “as2,” “as3,” etc.

In the modification example, the value of the agg_point attribute is set to the value of the id of the seg component, but the present invention is not limited thereto. For example, the value of the attribute can be designated by a time. In the modification example, a combination example of the agg_point attribute and the agg_seg_num attribute has been described, but a combination of the seg_dur attribute and the agg_seg_dur attribute indicating the segment lengths can also be realized, of course.

### Third Modification Example of Delivery System

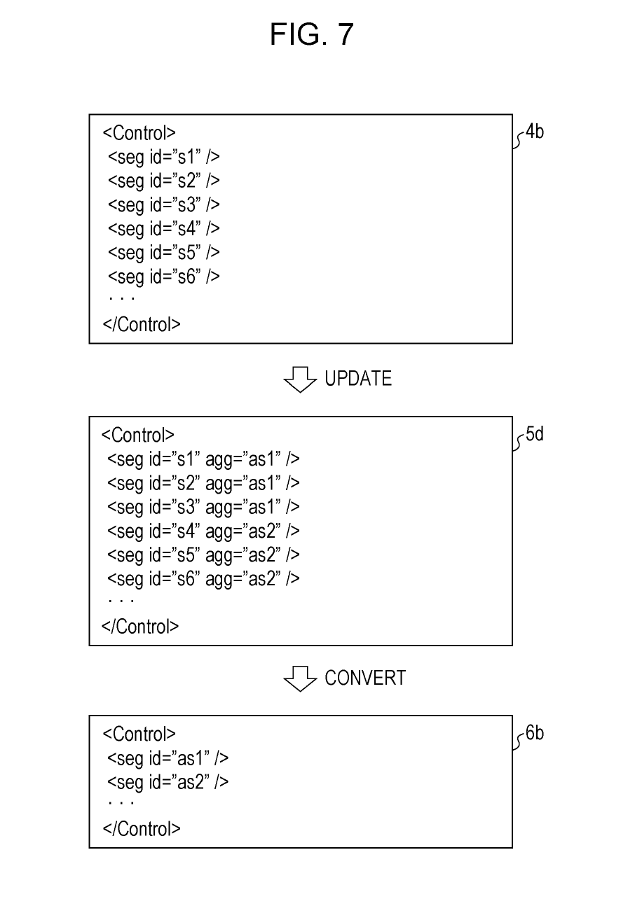

A third modification example of the delivery system according to the first embodiment will be described with reference to FIGS. 3 and 7. FIG. 7 is a diagram schematically illustrating control information handled in the delivery system according to the third modification example.

The delivery system according to the third modification example is different from the delivery system according to the first modification example in that operations of the control information update unit, the segment conversion unit, and the control information conversion unit are different.

That is, on the side of the delivery device, the control information update unit updates the control information for live delivery of the storage unit 110 by assigning an agg attribute that has the value of an id assigned to the integrated media segment as an attribute value to the seg component of each media segment (for example, each of 3 media segments) to be integrated together. For example, the control information update unit updates control information 4b in FIG. 7 to control information 5d in FIG. 7.

On the side of the playing device, the control information conversion unit updates control information for live delivery to control information for recording and playing based on an attribute value of the agg attribute included in the control information for live delivery. Specifically, a seg component aggregate with the same attribute value as the agg attribute is converted into a single seg component. For example, as illustrated in FIGS. 3 and 7, the control information conversion unit converts 3 seg components regarding 3 media segments (#s1 to #s3) into a seg component of an integrated single media segment (#as1) based on the attribute value of the agg attribute. The same also applies to media segments with an id after “s4.” As a result, the control information conversion unit 230 converts the control information 5d in FIG. 7 to control information 6b.

When 3 media segments for live delivery corresponding to the 3 seg components with the same attribute value as the attribute value of the agg attribute are supplied, the segment conversion unit integrates the 3 media segments into the single media segment for recording and playing with reference to the control information 5d in FIG. 5. For example, the segment conversion unit integrates the 3 media segments (#s1 to #s3) in FIG. 3 into the single media segment (#as1) in FIG. 3.

In the modification example, the value (“as1” or the like) of the id of the integrated media segment has been described as the value of the agg attribute. In this way, it is easy to allocate an id at the time of the control information conversion. Of course, the same value may be described in the agg attributes of the media segments to be integrated and the value is not limited to the foregoing value. The same description may also be configured to be made in some of the values of the agg attributes of the media segments to be integrated. For example, 3 media segments to which an id=“as1-1,” an id=“as1-2,” and an id=“as1-3” are appended may be integrated into a segment with an id=“as1.”

The control information 4b and the control information 6b in FIG. 7 are interpreted as control information for live delivery and control information for VOD delivery (recording and playing), respectively. Therefore, Control component tags of the control information 4b and the control information 6b may further have information indicating the component tags. Specifically, the Control component tag of the control information 4b may be set to <Control profile=“Live”> and the Control component tag of the control information 6b may be set to <Control profile=“on Demand”>.

### Fourth Modification Example of Delivery System

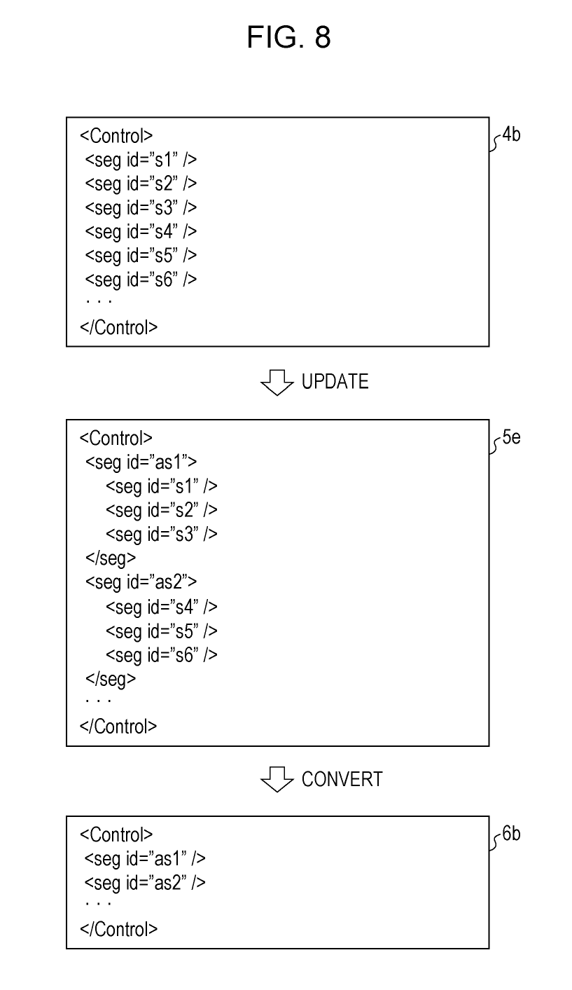

A fourth modification example of the delivery system according to the first embodiment will be described with reference to FIGS. 3 and 8. FIG. 8 is a diagram schematically illustrating control information handled in the delivery system according to the fourth modification example.

The delivery system according to the fourth modification example is different from the delivery system according to the first modification example in that operations of the control information update unit, the segment conversion unit, the control information conversion unit, and the playing unit are different.

That is, on the side of the delivery device, the control information update unit updates the control information for live delivery of the storage unit 110 to control information for live delivery and recording playing by updating each of the seg component aggregate corresponding to the media segment aggregate integrated together to a component, which is a seg component for which each seg component of the seg component aggregate is a lower component and is a seg component (hereinafter also referred to as a “higher seg component”) having the value of an id assigned to the integrated media segment as the attribute value of an id attribute. For example, the control information update unit updates control information 4b in FIG. 8 to control information 5e in FIG. 8.

On the side of the playing device, the control information update unit converts the control information for live delivery and recording playing to dedicated control information for recording and playing by leaving each description of the higher seg component included in the updated control information without changing and deleting the description of the lower seg component included in the higher seg component. For example, the control information conversion unit converts the control information 5e in FIG. 8 into control information 6b. Here, since a segment for recording and playing can be played even in the control information for live delivery and recording playing, the process of converting the control information into the dedicated control information for recording and playing may not be necessarily executed.

Whenever the media segments for live delivery of an aggregate corresponding to the seg component aggregate present lower than the higher seg components are supplied in regard to the higher seg components included in the supplied control information, the segment conversion unit integrates the media segments of an aggregate into the single media segment for recording and playing. For example, when the control information 5e in FIG. 8 is supplied and the 3 media segments (#s1 to #s3) in FIG. 3 respectively having “s1” to “s3” as the attribute values of the id attributes are supplied, the 3 media segments are integrated into the single media segment (#as1).

The playing unit lively plays the media segment aggregate for live delivery based on the supplied control information. Specifically, the media segment aggregate for live delivery is lively played with reference to only the lower seg components and without reference to the higher seg components among the seg components described in the control information.

In the delivery system according to the fourth modification example, the playing device may not include the control information conversion unit. In this case, the playing unit may read the control information for live delivery and recording playing from the storage unit 250 and read the media segment aggregate for recording and playing from the storage unit 250 to play the media segments at the time of the recording and playing. Specifically, the media segment aggregate for recording and playing may be played with reference to only the higher seg components and without reference to the lower seg component among the seg components described in the control information.

### Second Embodiment

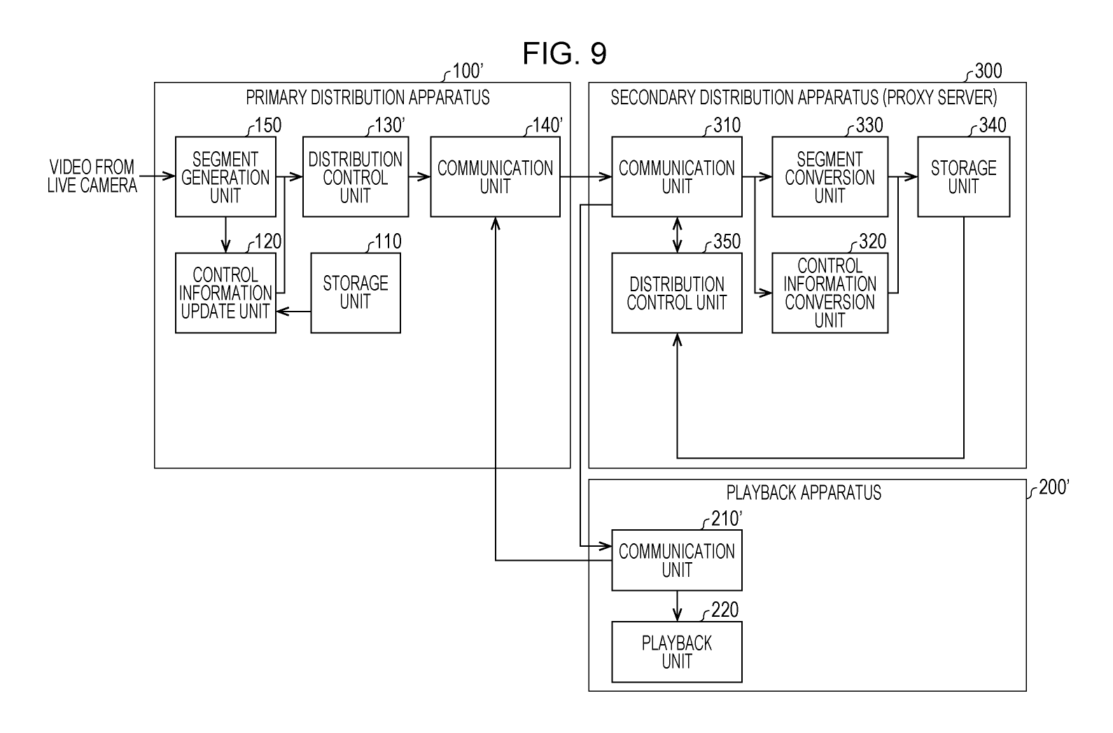

Another embodiment of the present invention will be described with reference to FIG. 9. FIG. 9 is a diagram illustrating the configurations of main units of a delivery device and a playing device included in a delivery system according to the embodiment.

In the delivery system according to the embodiment, a primary delivery device delivers a program video of a live camera to a second delivery device (proxy server) through communication, and the secondary delivery device lively delivers the program video of the live camera to a playing device having transmitted a request for live delivery to the primary delivery device. In the embodiment, although no description is particularly made, the live delivery to the playing device may be realized not via the secondary delivery device, but the primary delivery device may, of course, deliver a program video to each of the secondary delivery device and the playing device.

The secondary delivery device records the program video of the live camera in a recording scheme proper for VOD delivery and delivers the program video to a playing device having transmitted a request for VOD delivery in a VOD manner.

As illustrated in FIG. 9, the delivery system according to the embodiment includes a primary delivery device 100′, a playing device 200′, and a secondary delivery device 300.

### (Primary Delivery Device 100′)

As illustrated in FIG. 9, the primary delivery device 100′ includes a storage unit 110, a control information update unit 120, a delivery control unit 130′, a communication unit 140′, and a segment generation unit 150. Of these units, the storage unit 110, the control information update unit 120, and the segment generation unit 150 have been described in the first embodiment, and thus the description thereof will be omitted herein.

### (Delivery Control Unit 130′)

When the delivery control unit 130′ receives a request for live delivery from the playing device 200′, the delivery control unit 130′ transmits control information for live delivery and media segments for live delivery to the secondary delivery device 300. The transmitted control information and media segments for live delivery are transmitted to the playing device 200′ via the communication unit 310 of the secondary delivery device 300 without change. In the delivery from the primary delivery device 100′ to the secondary delivery device 300, a request for live delivery from the playing device 200′ may not necessarily be triggered. For example, the delivery may be configured to start in advance at any time point set separately by a service provider.

### (Communication Unit 140′)

The communication unit 140′ is a communication interface that transmits the media segments and the control information.

### (Playing Device 200′)

As illustrated in FIG. 9, the playing device 200′ includes a communication unit 210′ and a playing unit 220. The playing unit 220 has been described in the first embodiment, and thus the description thereof will be omitted herein.

### (Communication Unit 210′)

The communication unit 210′ is a communication interface that transmits a request for program live delivery and VOD delivery or receives the media segments and the control information.

### (Secondary Delivery Device 300)

As illustrated in FIG. 9, the secondary delivery device 300 includes a communication unit 310, a control information conversion unit 320, a segment conversion unit 330, a storage unit 340, and a delivery control unit 350. The control information conversion unit 320, the segment conversion unit 330, and the storage unit 340 are the same as the control information conversion unit 230, the segment conversion unit 240, and the storage unit 250 described with reference to FIG. 1 in the first embodiment, respectively, and thus the description thereof will be omitted herein. In the first embodiment, the control information converted by the segment conversion unit 330 has been referred to as the recording and playing control unit, but converted control information formed by the control information conversion unit 320 according to the embodiment is referred to as VOD playing control information from the viewpoint that a use purpose is VOD playing. The described details of information are the same between the control information for recording and playing and the VOD playing control information.

### (Communication Unit 310)

The communication unit 310 is a communication interface that transmits and receives a program video or the like of a live program (specifically, control information used for acquisition and playing of a program video and a media segment aggregate included in the program video).

### (Delivery Control 350)

When the delivery control unit 350 receives the control information for live delivery, the delivery control unit 350 delivers the control information to the playing device 200 (instructs the communication unit 310 to deliver the control information for live delivery received from the primary delivery device 100′ to the playing device 200′ without change) and supplies the control information to the control information conversion unit 320 and the segment conversion unit 330). When the delivery control unit 350 receives the media segments for live delivery, the delivery control unit 350 delivers the media segments to the playing device 200 (instructs the communication unit 310 to deliver the media segments for live delivery received from the primary delivery device 100′ to the playing device 200′ without change) and supplies the media segments to the segment conversion unit 330.

When the delivery control unit 350 receives a request for the VOD delivery from the playing device 200′, the delivery control unit 350 reads the VOD delivery control information from the storage unit 340 and delivers the VOD delivery control information to the playing device 200′, and sequentially reads the VOD delivery media segment aggregate from the storage unit 340 and delivers the VOD delivery media segment aggregate to the playing device 200′.

The configurations of the primary delivery device 100′, the playing device 200′, and the secondary delivery device 300 included in the delivery system according to the embodiment have been described roughly above.

### (Operation of Delivery System)

An operation of the delivery system in which the primary delivery device 100′ receives a request for the live delivery from the playing device 200′ will be described in brief with reference to FIG. 4.

First, the primary delivery device 100′ executes the process of S1 as in the delivery device 100, and then transmits the updated control information for live delivery to the secondary delivery device 300 (where the process corresponds to substitution of a transmission destination of S2 with the secondary delivery device 300).

The delivery control unit 350 of the secondary delivery device 300 transmits the control information for live delivery received by the communication unit 310 to the playing device 200′ and supplies the control information for live delivery to the control information conversion unit 320 and the segment conversion unit 330 (where the process corresponds to substitution of the supply to the playing unit in S3 with the transmission to the playing device 200′).

The control information conversion unit 320 supplied with the control information executes the process of S4 as in the control information conversion unit 230.

Thereafter, the delivery system repeats the subsequent processes up to S10 until the primary delivery device 100′ completes the generation of the segments.

That is, the primary delivery device 100′ transmits the generated segments to the secondary delivery device 300 (where the process corresponds to substitution of the transmission destination in S5 with the secondary delivery device 300), and then the delivery control unit 350 of the secondary delivery device 300 transmits the segments received by the communication unit 310 to the playing device 200′ and supplies the segments to the segment conversion unit 330 (where the process corresponds to substitution of the supply to the playing unit in S6 with the transmission to the playing device 200′).

Then, in the playing device 200′, the playing unit 220 plays the segments received by the communication unit 210′ (S7).

On the other hand, in the secondary delivery device 300, the segment conversion unit 330 executes the processes of S8 to S10 as in the segment conversion unit 240.

The operation of the delivery system from the start of the livery delivery to the completion of the live playing has been described above.

As understood from the above description, when a target program is a 60-minute program and the time length of the media segment for live delivery is 10 seconds, the primary delivery device 100′delivers 360 media segments for live delivery to the playing device 200′ via the secondary delivery device 300. When the time length of the media segment for recording and playing and VOD playing is 30 seconds, 120 media segments for recording and playing and VOD playing are preserved in the storage unit 340 of the secondary delivery device 300′ as the result of the foregoing operation. The control information for recording and playing and VOD playing used to sequentially play the 120 media segments for recording and playing and VOD playing are preserved in the storage unit 340.

Thereafter, when the playing device 200′ receives an instruction indicating the reception of the VOD delivery of the target program via an operation unit (not illustrated), the playing device 200′ request the secondary delivery device 300 to execute the VOD delivery. Then, the playing device 200′ receives the control information for recording and playing and VOD playing and sequentially receives the media segment aggregate for recording and playing and VOD playing from the secondary delivery device 300. The playing device 200′ sequentially plays the media segment aggregate while receiving the media segment aggregate based on the received control information.

### (Advantages of Secondary Delivery Device 300)

For example, the segment conversion unit 330 of the secondary delivery device 300 converts the 360 media segments with the time length of 10 seconds into the 120 media segments with the time length of 30 seconds by classifying the 360 media segments divided from the program content of the 60-minute live program into 3 groups in the time division manner and integrating the 3 media segments (time-divided data) of the respective groups.

The delivery control unit 350 of the secondary delivery device 300 delivers the playing information (seg component) regarding each of the 360 media segments and the control information for live delivery in which the number of media segments, “3,” to be classified into a single group is indicated to the playing device 200′ and lively delivers the 360 media segments to the playing device 200′. As described above, this process may be executed between the primary delivery device and the playing device without passing through the secondary delivery device 300.

The control information conversion unit 320 of the secondary delivery device 300 converts the live playing control information into the VOD playing control information in which the playing information (seg component) regarding each of the 120 media segments is indicated. The delivery control unit 350 delivers the VOD playing control information to the playing device 200′ and delivers the 120 media segments to the playing device 200′ in the VOD manner.

In the foregoing configuration, the storage unit 340 of the secondary delivery device 300 preserves the 120 VOD delivery media segments with the time length which is the triple of that of the media segments for live delivery.

Accordingly, as understood from the description of the first embodiment (the advantages of the playing device 200), it is possible to obtain the advantageous effect in which the secondary delivery device 300 can record the lively delivered program content for the VOD delivery more efficiently than in the related art.

It is possible to obtain the advantageous effect in which the number of requests for the VOD delivery of the media segments from the playing device 200′ to the secondary delivery device 300 is reduced to 120 requests which is ⅓ of the number (360) of requests for the live delivery of the media segments at the time of the live delivery.

The control information update unit 120 may be substituted with the control information update unit of the delivery device according to the first modification example described in the first embodiment. The control information conversion unit 320 and the segment conversion unit 330 may be substituted with the control information conversion unit and the segment conversion unit of the playing device according to the first modification example, respectively. The same also applies to the second to fourth modification examples described in the first embodiment. The playing unit 220 may be substituted with the playing unit of the playing device according to the fourth modification example described in the first embodiment.

### Third Embodiment

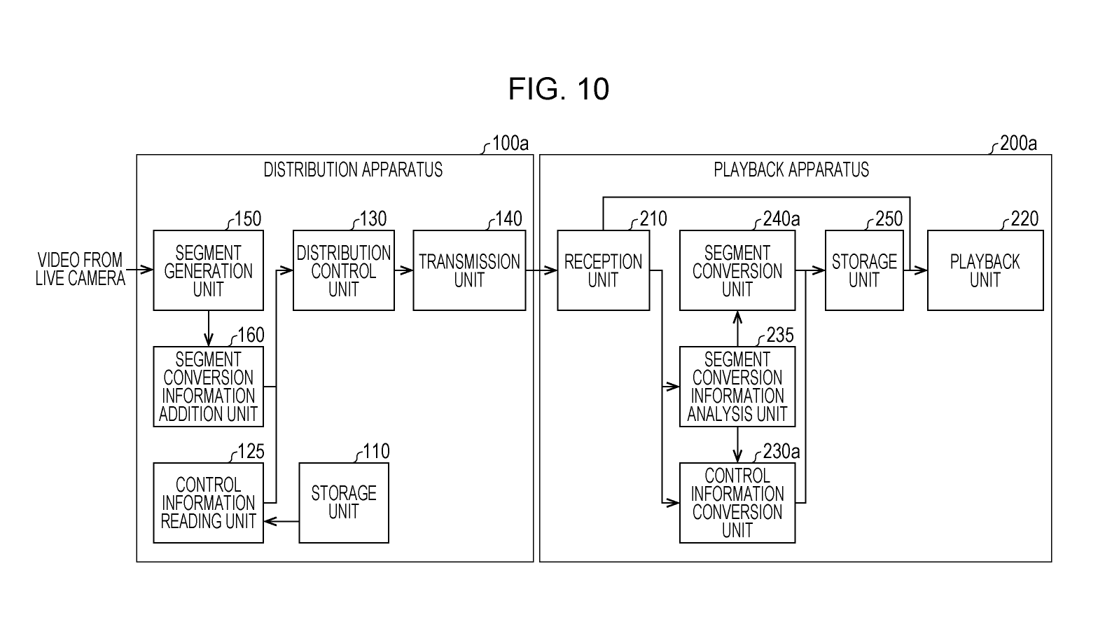

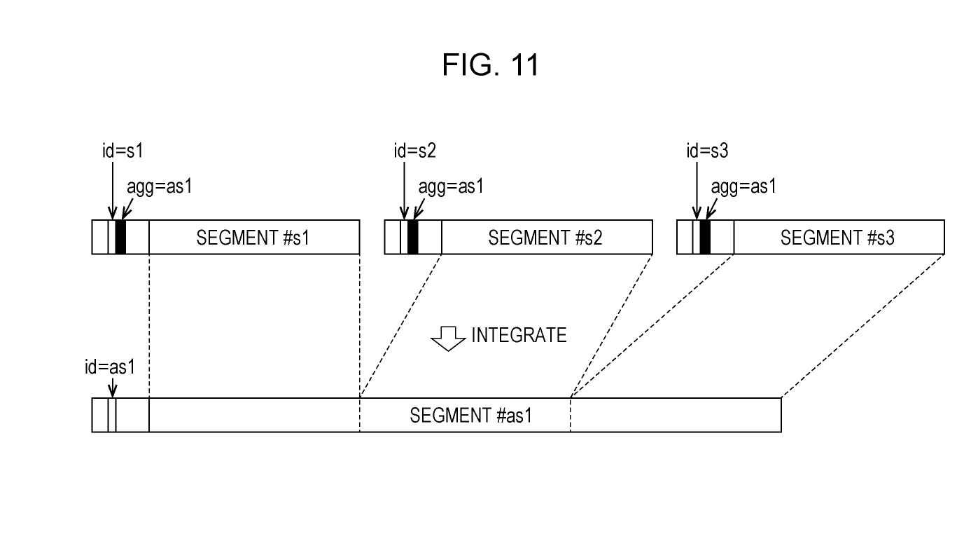

A delivery system according to still another embodiment of the present invention will be described with reference to FIGS. 10 and 11. FIG. 10 is a diagram illustrating the configurations of main units of a delivery device and a playing device included in a delivery system according to the embodiment. FIG. 11 is a diagram schematically illustrating media segment aggregate for live delivery before integration and a media segment for recording and playing after the integration.

In the delivery system according to the embodiment, as in the delivery system according to the first embodiment, the delivery device lively delivers a program video of a live camera through communication, and the playing device lively plays the delivered program video and the playing device records the program video during the live playing in conformity with an efficient recording scheme.

On the other hand, the delivery system according to the embodiment is different from the delivery system according to the first embodiment in that the delivery device adds the segment conversion information to a header portion of a media segment rather than control information.

Hereinafter, the configurations of the main units of the delivery system according to the embodiment will be described with reference to FIG. 10.

As illustrated in FIG. 10, the delivery system according to the embodiment includes a delivery device 100a and a playing device 200a.

(Delivery Device 100a)

As illustrated in FIG. 10, the delivery device 100a includes a storage unit 110, a control information reading unit 125, a delivery control unit 130, a transmission unit 140, a segment generation unit 150, and a segment conversion information addition unit 160. The storage unit 110 and the transmission unit 140 have been described in the first embodiment, and thus the description thereof will be omitted herein.

### (Control Information Reading Unit 125)

The control information reading unit 125 reads the control information preserved in the storage unit 110 and used for the live delivery and the live playing of the program video and supplies the control information to the delivery control unit 130.

### (Delivery Control Unit 130)

The delivery control unit 130 delivers control information for live delivery via the transmission unit 140. Whenever the media segment for live delivery is supplied, the delivery control unit 130 delivers the media segment that has a header portion including segment conversion information via the transmission unit 140.

### (Segment Generation Unit 150)

When a given period has passed during input of a video from the live camera, the segment generation unit 150 completes generation of the media segment including only the video within the period as video information and starts generating a subsequent media segment.

### (Segment Conversion Information Addition Unit 160)

When the media segment is supplied, the segment conversion information addition unit 160 adds the segment conversion information to the header portion of the media segment. Specifically, for each of the media segments of an aggregate to be integrated together, a variable agg is added to the header portion of the media segment when the media segment is supplied. The values of the variables agg added to the header portions of the media segments are the same and are the same as the value of a variable id included in the header portion of an integrated media segment.

For example, as illustrated in FIG. 11, the segment conversion information addition unit 160 adds the variable agg with a value of “as1” to the header portion of each of 3 media segments #s1 to #s3 to be integrated together.

In the following description of the embodiment, to facilitate the description, the variables agg and id added to the header portions of the media segments and a variable id added to a seg component of the control information are assumed to be variables having the same value and the value of the variable id is assumed to be information exchanged as information specifying each media segment. In practice, the variable id appended to the header portion of the media segment is independent from the variable id appended to the seg component of the control information. In this case, the same operation is executed by exchanging URI information or the like instructing the media segment as the information specifying the media segment.

(Playing Device 200a)

As illustrated in FIG. 10, the playing device 200a includes a reception unit 210, a playing unit 220, a control information conversion unit 230a, a segment conversion information analysis unit 235, a segment conversion unit 240a, and a storage unit 250. The reception unit 210, the playing unit 220, and the storage unit 250 have been described in the first embodiment, and thus the description thereof will be omitted herein.

### (Segment Conversion Information Analysis Unit 235)

The segment conversion information analysis unit 235 interprets the header portion (the variable agg) of each of the segments sequentially supplied from the reception unit 210, specifies the media segments of an aggregate to be integrated together, and supplies the ids of the specified media segments of an aggregate and an id (that is, the value of the variable agg) of the integrated media segment to the control information conversion unit 230a and the segment conversion unit 240a.

For example, when it is confirmed that “as1” is included as the value of the variable agg in the header portion of each of the 3 media segments #s1 to #s3 and “as2” is included as the value of the variable agg in the header portion of a fourth media segment #s4, the following process is executed. That is, the values (“s1” to “s3”) of the variables id of the header portions of the 3 media segments #s1 to #s3 and the value (“as1”) of the variable agg commonly included in the header portions of the 3 media segments #s1 to #s3 are supplied to the control information conversion unit 230a and the segment conversion unit 240a.

(Control Information Conversion Unit 230a)

The control information conversion unit 230a converts the control information for live delivery into control information for recording and playing and records the control information for recording and playing in the storage unit 250. At this time, information supplied from the segment conversion information analysis unit 235 is used for the conversion.

For example, the values (“s1” to “s3”) of the variables id of the header portions of the 3 media segments #s1 to #s3 and the value (“as1”) of the variable agg commonly included in the header portions of the 3 media segments #s1 to #s3 are supplied, 3 seg components of which the id of the control information 4b in FIG. 7 are “s1” to “s3” are integrated to be converted into the control information 6b in FIG. 7 for which the seg components are integrated into one seg component with an id of “as1” (that is, in the third modification example of the first embodiment, the segment conversion information agg written in the control information is written in the header portion of the media segment in the embodiment).

(Segment Conversion Unit 240a)

When the segment conversion information analysis unit 235 supplies the ids of the media segments for live delivery with the same value agg, the segment conversion unit 240a converts the media segments corresponding to the ids into a single media segment. Then, the value of the agg supplied from the segment conversion information analysis unit 235 is set in the integrated media segment.

For example, when the segment conversion unit 240a receives the values (“s1” to “s3”) of the 3 variables id and the value (“as1”) of the variable agg, as illustrated in FIG. 11, the segment conversion unit 240a integrates the 3 media segments #s1 to #s3 for live delivery into the single media segment #as1 for recording and playing.

The segment conversion unit 240a records the integrated single media segment in the storage unit 250 in association with the control information for recording and playing converted by the segment conversion unit 240a and corresponding to the program video including the media segments as constituents.

The configurations of the delivery device 100a and the playing device 200a included in the delivery system according to the embodiment have been described roughly above.

### (Operation of Delivery System)

Next, an operation of the delivery system according to the embodiment will be described below. The storage 110 of the delivery device 100a is assumed to preserve control information used for live delivery of a program video of a target program.

Before a start time of the live delivery, the control information reading unit 125 reads the control information for live delivery from the storage unit 110 and supplies the control information for live delivery to the delivery control unit 130.

Subsequently, the delivery control unit 130 delivers the control information for live delivery via the transmission unit 140.

The reception unit 210 of the playing device 200a receiving the control information supplies the received control information to the playing unit 220 and the control information conversion unit 230a.

Thereafter, when the start time of the live delivery arrives, the delivery device 100a of the delivery system starts generating the media segments. Whenever the generation of the media segments is completed, the following processes are repeated.

That is, when the generation of the media segments is completed, the segment generation unit 150 supplies the media segments to the segment conversion information addition unit 160.

The segment conversion information addition unit 160 adds the segment conversion information to the supplied media segments. Specifically, the agg with the same value of the agg of each of one or more different media segments to be integrated together is added to the header portion of the supplied segment.

Then, the delivery control unit 130 receiving the media segments to which the segment conversion information is assigned from the segment conversion information addition unit 160 delivers the media segments via the transmission unit 140 in response to a request from the playing device 200a.

The reception unit 210 of the playing device 200a receiving the media segments supplies the received media segments to the playing unit 220 and the segment conversion information analysis unit 235.

The playing unit 220 lively plays a video using the control information for live delivery and the media segments.

The segment conversion information analysis unit 235 determines whether the value of the agg of the supplied media segment is different from the value of the agg of the previously supplied media segment.

When the segment conversion information analysis unit 235 determines that these values are not different from each other, the supplied media segment is supplied to the segment conversion unit 240a. Conversely, when it is determined that these values are different from each other, the supplied media segment is supplied to the segment conversion unit 240a. The value of the id of each of the media segments of an aggregate which are recently supplied and in which the agg with the same value is included in the header portion and the same value of the agg in each media segment are supplied to the control information conversion unit 230a and the segment conversion unit 240a.

The control information conversion unit 230a updates the control information in the storage unit 250 based on the value of each id and the value of the agg received from the segment conversion information analysis unit 235. For example, when the control information 4b in FIG. 7 is recorded in the storage unit 250, “s1” to “s3” are received as the values of the ids, and “as1” is received as the value of the agg, 3 seg components on the control information 4b are updated to the first seg component on the control information 6b in FIG. 7.

On the other hand, based on the value of each id and the value of the agg received from the segment conversion information analysis unit 235, the segment conversion unit 240a updates the already received media segments for live delivery of the foregoing aggregate into the single media segment for recording and playing. For example, when “s1” to “s3” are received as the values of the ids and “as1” is received as the value of the agg, the already received 3 media segments #s1 to #s3 for live delivery are integrated into the single media segment #as1 for recording and playing. Then, the segment conversion unit 240a preserves the integrated media segment #as1 in the storage unit 250.

The playing unit 220 plays the recorded video using the control information for recording and playing and the media segments for recording and playing preserved in the storage unit 250.

In the delivery system, whenever the delivery device 100a completes the generation of the segments, the control information for recording and playing and the media segment aggregate for recording and playing are preserved in the storage unit 250 by repeating the foregoing processes.

When an instruction to record and play the target program is received via an operation unit (not illustrated), the playing device 200a first reads the control information for recording and playing from the storage unit 250 and sequentially reads and plays the media segment aggregate for recording and playing based on the control information for recording and playing.

Accordingly, in the playing device 200a according to the embodiment, it is also possible to obtain the same advantageous effects as the playing device 200 according to the first embodiment.

### First Modification Example of Delivery System

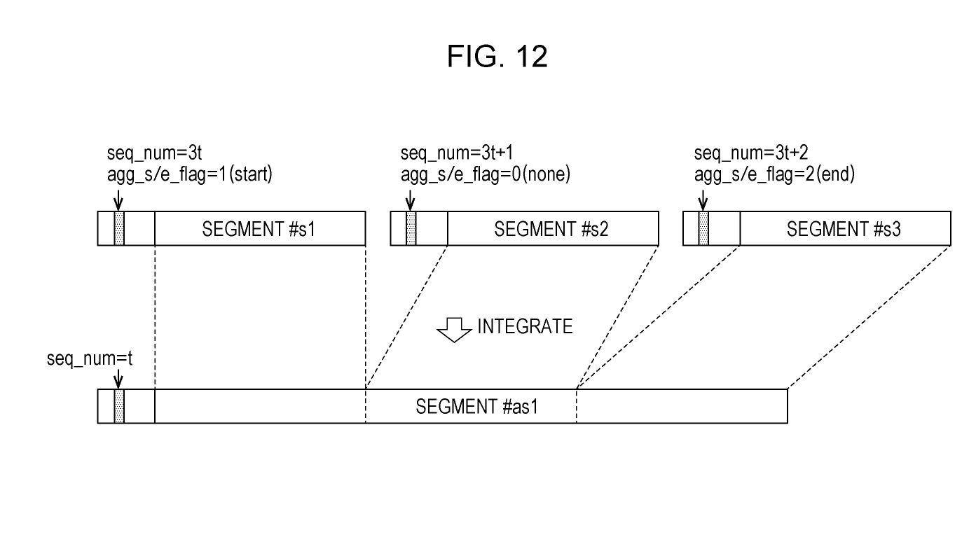

A first modification example of the delivery system according to the third embodiment will be described with reference to FIG. 12. FIG. 12 is a diagram schematically illustrating a media segment aggregate for live delivery before the integration which the delivery device delivers to the playing device and a media segment after the integration in the delivery system according to the first modification example.

The delivery system according to the first modification example is different from the above-described delivery system in that operations of the segment conversion information addition unit, the segment conversion information analysis unit, the control information conversion unit, the segment conversion unit, and the playing unit are different.

In the delivery system according to the first embodiment, the segment conversion information addition unit assigns seg_num which is a sequence number to each media segment. For the contiguous media segments of an aggregate to be integrated together, the segment conversion information addition unit assigns agg_s/e_flag with a value of “1” to a starting media segment, assigns agg_s/e_flag with a value of “2” to an ending media segment, and assigns agg_s/e_flag with a value of “0” to the other media segments. That is, agg_s/e_flag is a flag that indicates that the media segment to which agg_s/e_flag is appended is the starting or ending segment of the contiguous media segments of an aggregate to be integrated.

The segment conversion information analysis unit supplies the supplied media segments to the segment conversion unit 240a. The segment conversion information analysis unit determines whether the values of agg_s/e_flag of the supplied media segments are “0,” “1,” or “2.”

The delivered media segments may not be said to arrive at the playing device in the delivery order of the delivery device via a communication path. Therefore, based on the values of seq_num of the media segments with agg_s/e_flag of the values “1” and “2” and the values of seq_num of the media segments with agg_s/e_flag of the value “0,” the segment conversion information analysis unit confirms whether all of the media segments are lined between the media segment with agg_s/e_flag of the value “1” and the media segment with agg_s/e_flag of the value “2” when the media segment with agg_s/e_flag of the value “1” and the media segment with agg_s/e_flag of the value “2” are determined. When it is determined that all of the media segments are lined, the values of seq_num of the media segment with agg_s/e_flag of the value “1” and the media segment with agg_s/e_flag of the value “2” are supplied to the control information conversion unit and the segment conversion unit.

The control information conversion unit obtains a quotient obtained by dividing the supplied value of seq_num of the media segment with agg_s/e_flag of the value “1” by the number of the media segment with agg_s/e_flag of the value “1” to the media segment with agg_s/e_flag of the value “2” (that is, the number between the supplied seq_num) and determines the quotient as an attribute value of an id attribute of the seg component regarding the integrated media segment. For example, when “3t” and “3t+2” are supplied as the values of seq_num, “t” is determined as the attribute value of the id attribute of the seg component regarding the integrated media segment. A seg component aggregate regarding the media segments of the foregoing aggregate included in the control information of the storage unit 250 is updated to a seg component regarding the integrated media segment.

The segment conversion unit integrates the corresponding media segments of an aggregate into the single media segment for recording and playing based on the supplied values of seq_num and records the single media segment for recording and playing in the storage unit 250. For example, when “3t” and “3t+2” are supplied as the values of seq_num, the media segments of an aggregate of which the values of seq_num are “3t,” “3t+1,” and “3t+2” are integrated into the single media segment for recording and playing and “t” is set as the value of seq_num included in the header portion of the integrated media segment. The value of t is obtained according to the same method as the control information conversion unit.

The playing unit reads the seg components in the control information in the order from the top. The media segments of which the header portions include seq_num of the same value in the attribute value of the id attribute of the seg component are read and played in the order in which the seg components are read.

### Second Modification Example of Delivery System

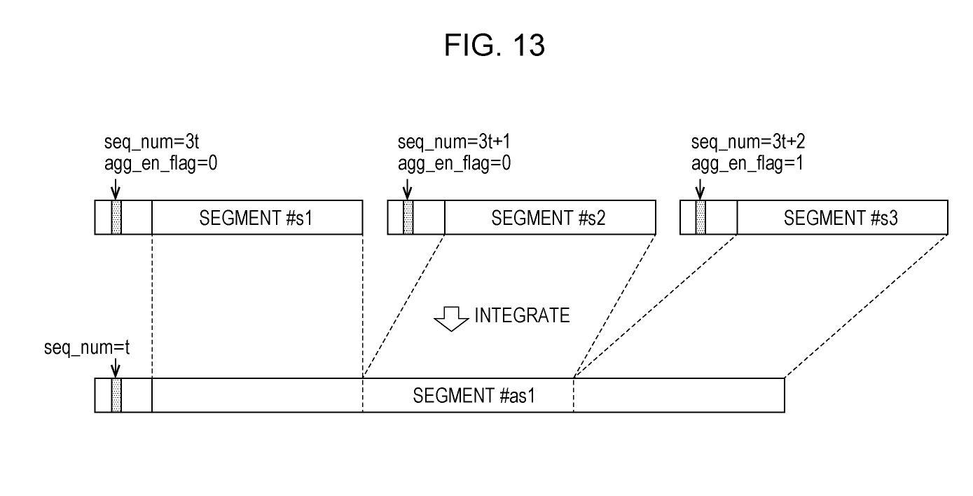

A second modification example of the delivery system according to the third embodiment will be described with reference to FIG. 13. FIG. 13 is a diagram schematically illustrating a media segment aggregate for live delivery before the integration which the delivery device delivers to the playing device and a media segment after the integration in the delivery system according to the second modification example.

The delivery system according to the second modification example is different from the delivery system according to the first modification example in that operations of the segment conversion information addition unit, the segment conversion information analysis unit, the segment conversion unit, and the control information conversion unit are different.

In the delivery system according to the second modification example, the segment conversion information addition unit assigns seg_num which is a sequence number to each media segment. For the contiguous media segments of an aggregate to be integrated together, the segment conversion information addition unit assigns agg_en_flag with a value of “1” to an ending media segment and assigns agg_en_flag with a value of “0” to the other media segments. That is, agg_en_flag is a flag that indicates that the media segment to which agg_en_flag is appended is the ending segment of the contiguous media segments of an aggregate to be integrated.

The segment conversion information analysis unit supplies the supplied media segments to the segment conversion unit. The segment conversion information analysis unit determines whether the values of agg_en_flag of the supplied media segments are “0” or “1.”

As described in the first modification example, the delivered media segments may not be said to arrive at the playing device in the delivery order of the delivery device via a communication path. In the second modification example, when it is determined that the value of agg_en_flag is “1,” it is determined whether the value of seq_num of the newly determined media segment is a subsequent correct value of seq_num in comparison to the value of seq_num of the media segment recently determined to have the same value “1.” Subsequently, using the values of seq_num of the media segments of which the value of agg_en_flag is “0,” it is determined whether the media segments between the media segments with agg_en_flag of the value “1” are lined. When it is determined that the media segments are lined, the values of seq_num of the media segments with agg_en_flag of the value “1” are supplied to the control information conversion unit and the segment conversion unit.

When the segment conversion unit newly receives the value of seq_num of the media segment with agg_en_flag of the value “1,” the segment conversion unit integrates the media segments of an aggregate, from the media segment subsequent to the immediately previous media segment with agg_en_flag of the value “1” to the media segment with agg_en_flag of the value “1” indicated by the newly received value of seq_num, using the newly received value of seq_num and the value of seq_num of the immediately previously acquired media segment with agg_en_flag of the value “1.”

When the control information conversion unit newly receives the value of seq_num of the media segment with agg_en_flag of the value “1,” the control information conversion unit integrates the seg components corresponding to the media segments of an aggregate into one seg component, from the media segment subsequent to the immediately previous media segment with agg_en_flag of the value “1” to the media segment with agg_en_flag of the value “1” indicated by the newly received value of seq_num, using the newly received value of seq_num and the value of seq_num of the immediately previously acquired media segment with agg_en_flag of the value “1.”

### Third Modification Example of Delivery System

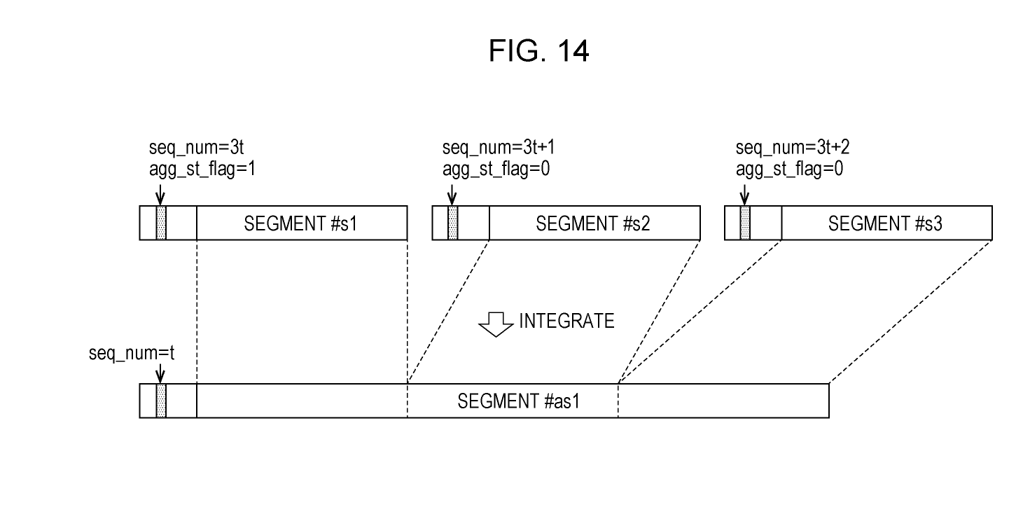

A third modification example of the delivery system according to the third embodiment will be described with reference to FIG. 14. FIG. 14 is a diagram schematically illustrating a media segment aggregate for live delivery before the integration which the delivery device delivers to the playing device and a media segment after the integration in the delivery system according to the third modification example.

The delivery system according to the third modification example is different from the delivery system according to the first modification example in that operations of the segment conversion information addition unit, the segment conversion information analysis unit, the segment conversion unit, and the control information conversion unit are different.

In the delivery system according to the third embodiment, the segment conversion information addition unit assigns seg_num which is a sequence number to each media segment. For the contiguous media segments of an aggregate to be integrated together, the segment conversion information addition unit assigns agg_st_flag with a value of “1” to a starting media segment and assigns agg_st_flag with a value of “0” to the other media segments. That is, agg_st_flag is a flag that indicates that the media segment to which agg_st_flag is appended is the starting segment of the contiguous media segments of an aggregate to be integrated.

The segment conversion information analysis unit supplies the supplied media segments to the segment conversion unit. The segment conversion information analysis unit determines whether the values of agg_st_flag of the supplied media segments are “0” or “1.”

When the segment conversion information analysis unit determines that the value of agg_st_flag is “1,” the segment conversion information analysis unit determines whether the value of seq_num of the newly determined media segment is a subsequent correct value of seq_num in comparison to the value of seq_num of the media segment recently determined to have the same value “1.” Subsequently, using the values of seq_num of the media segments of which the value of agg_st_flag is “0,” it is determined whether the media segments between the media segments with agg_st_flag of the value “1” are lined. When it is determined that the media segments are lined, the values of seq_num of the media segments with agg_st_flag of the value “1” are supplied to the control information conversion unit and the segment conversion unit.

When the segment conversion unit newly receives the value of seq_num of the media segment with agg_st_flag of the value “1,” the segment conversion unit integrates the media segments of an aggregate, from the media segment subsequent to the immediately previous media segment with agg_st_flag of the value “1” to the media segment immediately previous to the media segment with agg_st_flag of the value “1” indicated by the newly received value of seq_num, using the newly received value of seq_num and the value of seq_num of the immediately previously acquired media segment.

When the control information conversion unit newly receives the value of seq_num of the media segment with agg_st_flag of the value “1,” the control information conversion unit integrates the seg components corresponding to the media segments of an aggregate into one seg component, from the immediately previous media segment with agg_st_flag of the value “1” to the media segment immediately previous to the media segment with agg_st_flag of the value “1” indicated by the newly received value of seq_num, using the newly received value of seq_num and the value of seq_num of the immediately previously acquired media segment with agg_st_flag of the value “1.”

### Fourth Modification Example of Delivery System

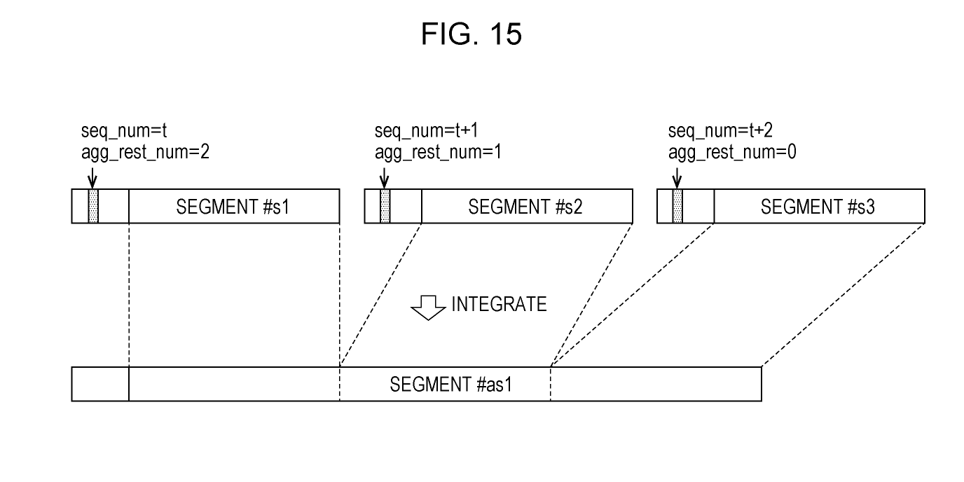

Even when agg_en_flag of the second modification example is substituted with an attribute value agg_rest_num indicating the number of remaining media segments to be integrated, the same process can be executed. FIG. 15 illustrates an example of media segments. Here, agg_rest_num=“0” is substantially equivalent to agg_en_frag=“1.”

The control information conversion unit 230a or the control information conversion unit of each of the first to fourth modification examples may convert the control information for live delivery into control information for live delivery and recording playing.

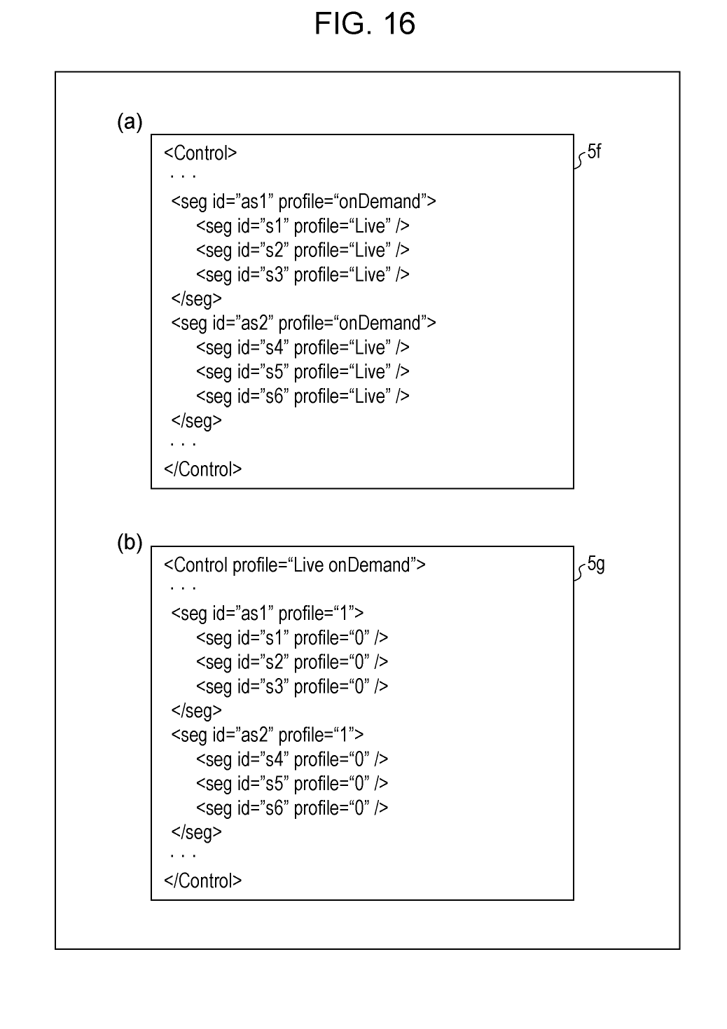

For example, the control information 4b in FIG. 7 may be updated to control information 5f in FIG. 16(a) or may be updated to control information 5g in FIG. 16(b). A profile attribute of a seg component in the control information 5f indicates that the seg component is referred to only at the time of recording and playing when the attribute value of the profile attribute is “on Demand,” and indicates that the seg component is referred to only at the time of live playing when the attribute value of the profile attribute is “Live.” The profile attribute of which the attribute value is “Live” in the control information 5f may be omitted. In this case, the playing unit refers to the seg component with no profile attribute only at the time of live playing.

The control information 5g shows an example in which a profile attribute defining a value which the profile attribute of a lower seg component can have is described in a Control component. In a case in which the attribute value of the profile attribute of the Control component is a binary value of “Live on Demand,” the profile attribute of the seg component indicates “on Demand” when the attribute value is “1” and indicates that the seg component is referred to only at the time of recording and playing. On the other hand, when the attribute value is “0,” the profile attribute of the seg component indicates “Live” and the seg component is referred to only at the time of live playing. The profile attribute of which the attribute value is “0” in the control information 5g may be omitted. In this case, the playing unit refers to the seg component with no profile attribute only at the time of live playing.

Of course, the control information illustrated in FIG. 16 can be used in either of the first embodiment or the second embodiment.

### (Supplement 1)

The value of N in steps S8 and S9 in the first embodiment may be determined in advance in the delivery device 100 or may be a value based on a value input via an operation unit (not illustrated) by a program provider using the delivery device 100. That is, the values of “30 s” which is the attribute value of the attribute agg_seg_dur or “3” which is the attribute value of the attribute agg_seg_num may be determined in advance in the delivery device 100 or may be a value input via an operation unit (not illustrated) by the program provider using the delivery device 100. Of course, the values of “30 s” and “3” are merely examples and the present invention is not limited thereto.

The values of “as1” and “as2” in the first embodiment may be values assigned according to a rule determined in advance in the delivery device 100 or the playing device 200.

In the third modification example of the first embodiment, the number of contiguous seg components to which the control information update unit 120 adds the variable agg with the same value may be determined in advance in the delivery device 100 or may be a value based on a value input via an operation unit (not illustrated) by the program provider using the delivery device 100. The number of seg components may not be fixed and a different number of seg components may be set for each of the media segments to be integrated. In this case, the value of N in steps S8 and S9 in the first embodiment is also different for each of the media segments to be integrated.

In the third embodiment, the number of contiguous media segments to which the segment conversion information addition unit 160 assigns the variable agg with the same value may be determined in advance in the delivery device 100a or may be a value based on a value input via an operation unit (not illustrated) by a program provider using the delivery device 100a. The number of media segments may not be fixed and a different number of media segments may be set for each of the media segments to be integrated.

The values of the ids of the media segments may not be contiguous numbers, but may be time values indicating the times at which the generation of the media segments is started or is completed. Combination type values in which the title of a video and contiguous numbers are concatenated can also be set.

In the second and third modification examples of the third embodiment, agg_en_flag and agg_st_flag may not be the flags in which the values of “0” and “1” are set, but agg_en_flag and agg_st_flag may also be set as identifiers that indicate an ending segment among the segments to be integrated and a starting segment among the segments to be integrated. That is, the media segment to which agg_en_flag is appended may be configured to indicate the ending segment of the segments to be integrated and the identifier agg_en_flag may be configured not to be appended to the other media segments.

### (Supplement 2)

The value of N in steps S8 and S9 in the first embodiment is preferably a value indicating that a head position of each integrated media segment is a random access point.

That is, for example, when program content in which the length of the media segment for live delivery is 10 seconds and the random access points are arranged at intervals of 25 seconds is delivered, the control information update unit 120 of the delivery device 100 may update the control information by adding the attribute agg_seg_num with an attribute value of “5” (which is a quotient obtained by dividing the least common multiple of 25 and 10 by 10) to the control information of the storage unit 110.

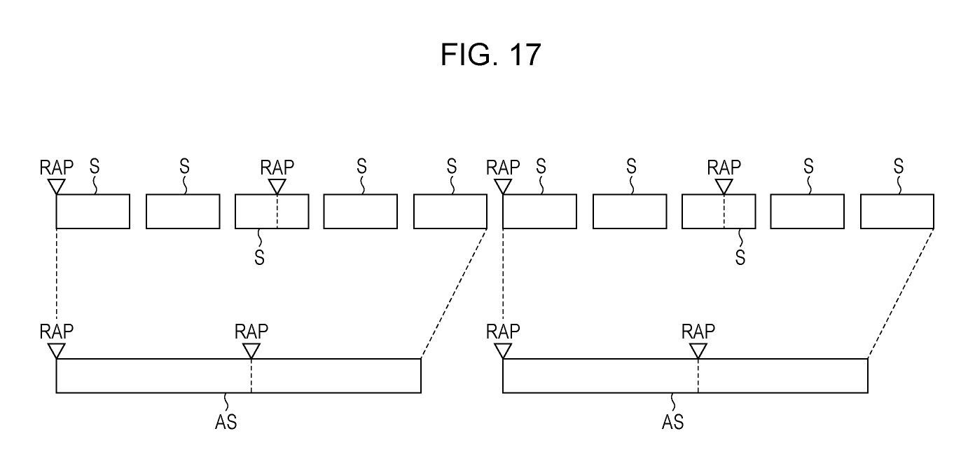

In this case, as illustrated in FIG. 17, whenever the playing device 200 receives 5 media segments S for live delivery, the playing device 200 integrates the 5 media segments S into a single media segment AS for recording and playing. Then, as illustrated in FIG. 17, the head position of each of the media segments AS for recording and playing is a random access point (“RAP” in the drawing).

Alternatively, conversion can also be executed such that it is determined whether the random access point (RAP) is located at the head position of the segment by using information regarding the segment and a segment having a large length is formed using a segment having a small length and having the RAP at the head position as a base point. That is, the segment having the small length and the having RAP at the head position to the segment immediately previous to the subsequent segment having the small length and having the RAP at the head position are integrated to form the segment having the large length. In this case, information indicating presence or absence of the RAP or the position of the RAP may be added to the header of each of the segments having the small length and components of an aggregate to be integrated into a single media segment may be specified using this information. That is, the information indicating presence or absence of the RAP or the position of the RAP can be used as segment conversion information.

Since a content generator knows random accessible positions in the content data (the media segments), it is suitable to transmit setting or the like of the media segment having a large length and starting from the random access point from a provider side, that is, the delivery device. By transmitting necessary information from the delivery device, the media segments can be integrated without special analysis of the playing device or the secondary delivery device.

In some cases, the provider side divides small segments in advance so that one segment having a large length can be configured by collecting the plurality of segments having the small length. Even in this case, by notifying of necessary minimum conversion information, it is possible to easily execute the conversion.

### (Supplement 3)

The delivery device 100 and the primary delivery device 100′ may include the segment conversion unit and the control information conversion unit. That is, whenever the delivery control unit delivers N media segments for live delivery, the segment conversion unit may integrate the N media segments into a single media segment and records the integrated single media segment in the storage unit 110 during the live delivery of the program content. Then, the control information conversion unit may convert the control information updated by the control information update unit into the control information for recording and playing during the live delivery of the program content.

That is, this can be said to be a configuration in which the primary delivery device 100′ also has the function of the secondary delivery device 300 in the second embodiment and a configuration in which the delivery device 100 and the primary delivery device 100′ are assumed to provide a special deliverable service, for example, retroactively execute time shift delivery or time shift playing of a played-backscene. This is because in order to retroactively execute the time shift delivery of the delivered scene, a provider server (the delivery device 100 or the primary delivery device 100′) needs to execute conversion into random accessible media segments with a large length and to retain the random accessible media segments.

The configuration of the delivery device 100 and the primary delivery device 100′ including the segment conversion unit and the control information conversion unit will be specifically described below.

The segment conversion unit records the media segments in the storage unit 110 whenever the media segments are delivered. Then, whenever the segment conversion unit records N media segments in the storage unit 110, the segment conversion unit reads the N media segments recently recorded in the storage unit 110 from the storage unit 110 and integrates the N media segments into a single media segment. In this way, the segment conversion unit updates the N media segments in the storage unit 110 to the single media segment.

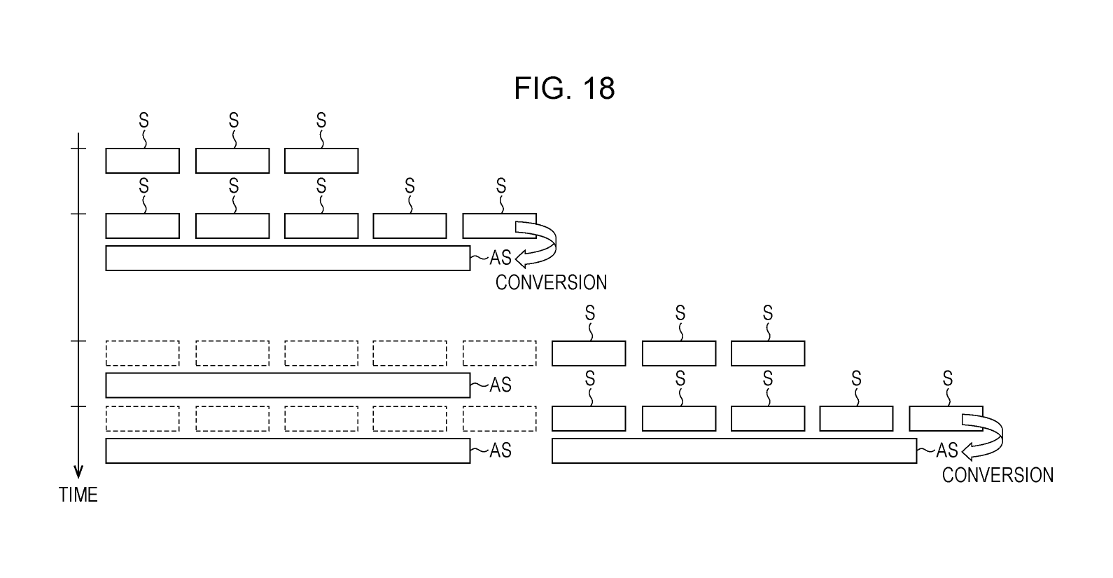

For example, when the value of N is 5 and the initial 3 media segments S are delivered by the delivery control unit, as illustrated in FIG. 18, the 3 media segments S for live delivery are preserved in the storage unit 110.

Thereafter, when the fifth media segment S for live delivery is delivered by the delivery control unit, the initial 5 media segments S preserved in the storage unit 110 are updated to a single media segment AS for recording and delivery. When the update is completed, the 5 media segments S (which correspond to the deleted media segments S for which a rectangle indicated by dotted lines in the drawing is deleted) preserved in the storage unit 110 are deleted from the storage unit 110.

When the eighth media segment S for live delivery is delivered by the delivery control unit, one media segment AS for recording and playing and 3 media segments S for live delivery (sixth to eighth media segments) are preserved in the storage unit 110.

Thereafter, when the tenth media segment S for live delivery is delivered by the delivery control unit, the 5 sixth to tenth media segments S in the storage unit 110 are updated to a single media segment AS for recording and delivery, and thus the two media segments AS for recording and delivery are preserved in the storage unit 110. When the update is completed, the 5 sixth to tenth media segments S are deleted from the storage unit 110.

As a result, when the live delivery ends, all of the media segments for recording and delivery included in the content are preserved in the storage unit 110.

Accordingly, the delivery device 100 and the primary delivery device 100′ can record and deliver the previously lively delivered content without unnecessary consumption of a storage space of the storage unit 110.

In the delivery device, can the control information is updated and delivered in the control information conversion unit along with the conversion of the segments. However, for the sake of the playing device making a request using the already delivered previous control information, the media segments for live delivery and the media segment for recording and delivery can also be designed to coexist in the delivery device for a given period. Such a design is particularly useful when the update of the control information is executed only periodically. Since the information regarding the media segments for live delivery and the media segment for recording and delivery coexists in the control information during the delivery, attribute information (for example, aggregated attribute) or an identifier indicating that the media segment described in the control information is the information regarding the integrated media segment for recording and playing can also be added to description (seg component) of the media segment. This is substantially the same as addition of the agg attribute to the media segments before the integration, but is separately described particularly since a function to be realized differs as follows. That is, the attribute information or the identifier indicates that the media segment for recording and delivery obtained by integrating the media segment aggregate for live delivery based on the previous control information is present in the delivery device. The playing device may makes a request for the media segment aggregate for live delivery before the integration using the previous control information (retention of the previous control information) or may makes a request for the media segment for recording and delivery after the integration using the updated control information (destruction of the previous control information). This process can be applied, for example, when the time shift playing of the delivered media segments is executed.

Not only is the foregoing attribute information or identifier described in the control information, but information indicating that the media segments are integrated may be added to a header portion of an HTTP response message during transmission when the media segments are integrated. For example, the information can be added as a media type parameter to a Content-Type header. Thus, the playing device can timely know that the media segments are integrated before acquisition of the updated control information.

### (Supplement 4)

The data structure of each of the media segments for live delivery and the data structure of the media segment for recording and playing integrated from the media segments will be described in brief.

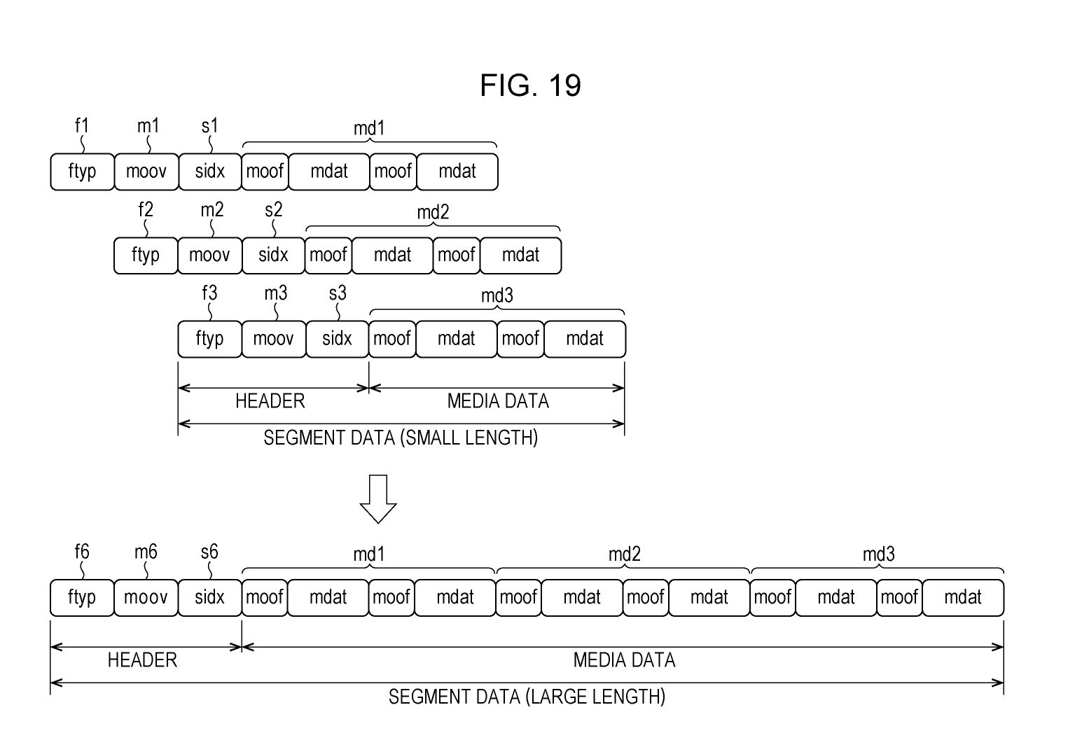

FIG. 19 is a diagram schematically illustrating the data structures of the media segments.

As illustrated in FIG. 19, either the live playing media segment or the media segment for recording and playing includes a header portion (which is a portion denoted by reference signs f1, m1, s1, and the like) and a media data portion (which is a portion indicated by reference signs md1, md2, md3, and the like).

Here, ftyp (File Type Box) denoted by reference signs f1 to f3 and f6 includes classification or version information of a segment file. Further, moov (Movie Box) denoted by reference signs m1 to m3 and m6 includes a criterion time or track information of the segment. Furthermore, sidx (Segment Index Box) denoted by reference signs s1 to s3 and s6 includes information regarding a random access point.

Here, moof (Movie Fragment Box) includes meta-information regarding a movie fragment included in the media segment and mdat (Media Data Box) includes video data of the movie fragment included in the media segment.

Next, an integration process of integrating the contiguous media segments for live delivery into the single media segment for recording and playing will be described in detail below.

In regard to the header portions, the segment conversion unit deletes ftyp (f1 to f3) of the media segments for recording and playing and generates and attaches ftyp (f6) of the media segment for recording and playing. Further, moov (m6) obtained by integrating the details of moov (m1 to m3) of the media segments is formed to be set to moov of the media segment for recording and playing. Likewise, sidx (s6) obtained by integrating the details of sidx (s1 to s3) of the media segments is formed to be set to sidx of the media segment for recording and playing.

On the other hand, the segment conversion unit generates a media data portion of the media segment for recording and playing by arranging pairs of moof and mdat of the delivered media segments of an aggregate in a delivered order from the beginning.

Through the foregoing process, for example, the segment conversion unit integrates 3 media segments schematically illustrated above the arrow of FIG. 19 into a single media segment schematically illustrated below the arrow of FIG. 19. That is, the segment conversion unit generates a media data portion in which the detail md1 of the media data portion of the initially delivered media segment is disposed at the starting, the detail md3 of the media data portion of the finally delivered media segment is disposed at the ending, and the detail md3 of the media data portion of the secondly delivered media segment is disposed between the starting and the ending.

Referring to sidx of each of the supplied media segments, the segment conversion unit preferably integrates the media segments from the media segment for live delivery that includes sidx indicating that the random access point is present at the starting position to the media segment until the same media segment is subsequently supplied.

### (Supplement 5)

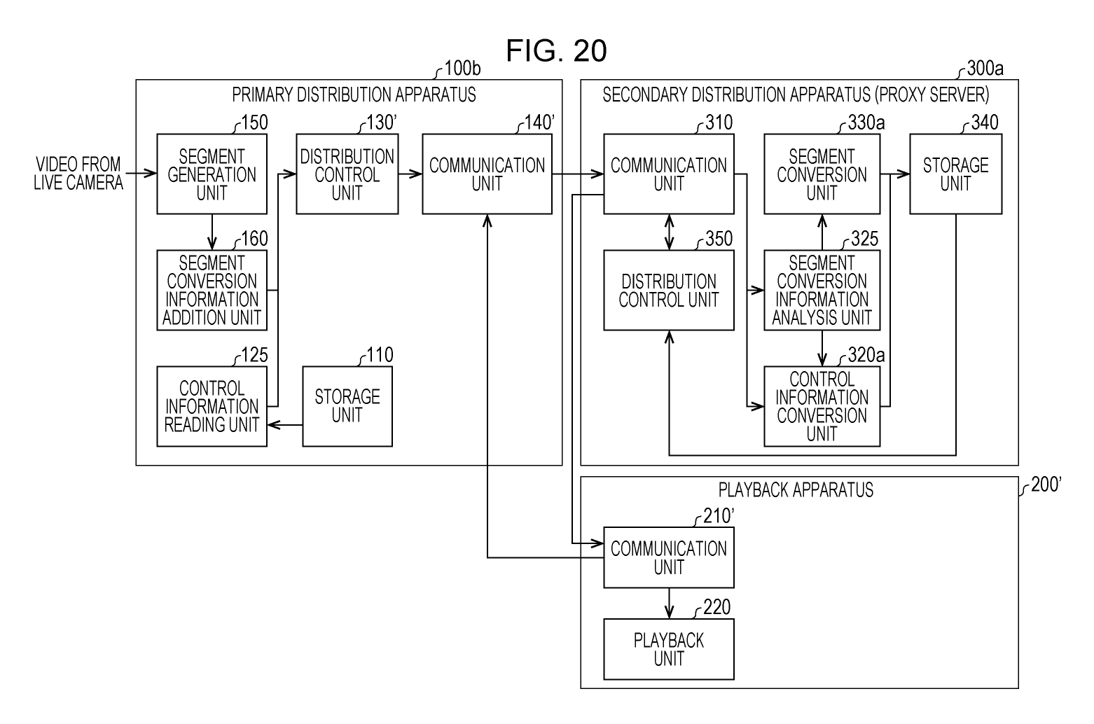

The present invention can be embodied in a combination form of the characteristics of the delivery system according to the second embodiment and the characteristics of the delivery system according to the third embodiment. For example, the present invention can be embodied as a delivery system that includes a primary delivery device 100b, a secondary delivery device (proxy server) 300a, and a playing device 200′ illustrated in FIG. 20.

That is, as in the primary delivery device 100′ according to the second embodiment, the primary delivery device 100b delivers a program video of a live camera to the secondary delivery device 300a. As in the secondary delivery device 300 according to the second embodiment, the secondary delivery device 300a lively delivers the program video of the live camera to the playing device 200′ having transmitted a request for live delivery to the primary delivery device 100b. As in the secondary delivery device 300, the secondary delivery device 300a records the program video of the live camera in a recording scheme proper for VOD delivery and delivers the program video in a VOD manner to the playing device having transmitted a request for the VOD delivery.

As in the delivery device 100a according to the third embodiment, a segment conversion information addition unit 160 in the primary delivery device 100b adds segment conversion information to a header portion of a media segment.

The detailed description of the delivery system will be omitted. As understood with reference to FIG. 20, the units included in the primary delivery device 100b, the secondary delivery device 300a, and the playing device 200′ have been described in any one of the first to third embodiments. Therefore, it should be apparent to those skilled in the art that the configuration of the delivery system can be understood although the detailed description is not made.

It should be apparent to those skilled in the art that an operation of the delivery system can also be understood from the description of the first to third embodiments. It is added that a control information conversion unit 320a and a segment conversion unit 330a are the same as the control information conversion unit 230a and the segment conversion unit 240a, respectively.

The segment conversion information addition unit 160 may be replaced with the segment conversion information addition unit of the delivery device according to the first modification example described in the third embodiment. The control information conversion unit 320a, a segment conversion information analysis unit 325, the segment conversion unit 330a, and a playing unit 220 may be replaced with the control information conversion unit, the segment conversion information analysis unit, the segment conversion unit, and the playing unit of the playing device according to the first modification example, respectively. The same also applies to the second to fourth modification examples described in the third embodiment.

### (Supplement 6)

In each embodiment of the present invention, the segment conversion process and the control information conversion process have been executed when the playing device or the secondary delivery device completes the acquisition of the media segments of an aggregate to be converted into the single media segment. Unlike this, the segment conversion process and the control information conversion process may be executed by separately obtaining information indicating a timing of the integration process. In an embodiment in which the media segments of an aggregate are not integrated as soon as the reception of the media segments of the aggregate is completed and the integration timing is separately instructed, a use purpose is assumed in which the media segments with a small length are retained for the live delivery during a certain period even after the reception of the media segments.

The following timing is considered as a timing of the integration process at which the segment conversion unit 240 integrates the segments for live delivery of an aggregate into a single media segment for recording and playing.

For example, the delivery control unit 130 may transmit a command instructing the segment conversion unit 240 of a conversion timing to the playing device 200 periodically (for example, every 30 seconds) or after the completion of the transmission of all the media segments for live delivery. The segment conversion unit 240 may execute the integration process at a timing at which the playing device 200 receives the command.

Time information indicating a timing at which the integration process is executed may be recorded in the control information for live delivery in the storage unit 110. The segment conversion unit 240 may execute the integration process at a timing according to time information recorded in the supplied control information.

The segment conversion information addition unit 160 may add information indicating that the integration process is executed to the metadata box or the header portion of the media segment supplied from the segment generation unit 150 at each prescribed timing. The segment conversion unit 240 may execute the integration process at a timing at which the media segment including such information is supplied.

The segment conversion information addition unit 160 is illustrated only in FIG. 10 of the third embodiment and FIG. 20 of Supplement 5, but may add information indicating the integration process is executed to the metadata box or the header portion of the media segment when the segment generation unit 150 in FIG. 1 of the first embodiment or the segment generation unit 150 in FIG. 9 of the second embodiment generates the media segment.

Specifically, the segment conversion information addition unit 160 or the segment generation unit 150 is assumed to generate a dedicated metadata box Segment Aggregation Box (this box is placed in the header portion of the media segment) used for announcement of the segment conversion information. Further, the fact that any of agg, the seq_num, agg_s/e_frag, agg_en_frag, agg_st_frag, and agg_rest_num described in the example of the delivery system according to the third embodiment and the first to fourth modifications is used is assumed to be described in the Segment Aggregation Box. Besides, a trigger flag agg trigger indicating the integration process is described in the Segment Aggregation Box.

When the value of the agg trigger of the header portion of the supplied media segment is “0,” the segment conversion unit 240 does not yet execute the integration process and records the supplied media segment in the storage unit. Conversely, when the value of the agg trigger of the header portion is “1,” the segment conversion unit 240 executes the integration process on the media segment aggregate of the storage unit which is not yet a target of the integration process at that time.

The agg trigger may be set as an identifier. When the agg trigger is not present in the header portion of the supplied media segment, the segment conversion unit 240 may not yet execute the integration process and may record the media segment in the storage unit. The integrated process may be executed on the media segment aggregate of the storage unit which is not yet the target of the integration process when the agg trigger is attached to the header portion of the supplied media segment.

As described above, agg_en_frag and agg_st_frag described above are information indicating the ending media segment and the starting media segment among the media segments to be integrated, and the information may be handled as a flag giving an instruction to execute the integration process. That is, agg_en_frag=“1” can be interpreted to be information giving an instruction to execute the integration up to the received media segments and agg_st_frag=“1” can be interpreted to be information giving an instruction to execute the integration up to the media fragment immediately previous to the received media fragment.

The Segment Aggregation Box is a dedicated metadata box placed in the header portion of the segment in parallel to the boxes ftyp, moov, and sidx in FIG. 19. The Segment Aggregation Box is illustrated as, for example, a sega box. Information indicating that the integration process is executed may be configured to be added to an existing box for announcement without using the dedicated metadata box. For example, a value ‘sagg’ instructing the integration process may be set as a value which a compatible_bands component (4-byte list) of the existing ftyp box has.

In this case, when the value ‘sagg’ is not present in the compatible_bands component of the ftyp box of the supplied media segment, the segment conversion unit 240 may not yet execute the integration process and may record the media segment in the storage unit. Conversely, when the value ‘sagg’ is present in the compatible_bands component of the ftyp box of the supplied media segment, the segment conversion unit 240 may execute the integration process on the media segments of the storage unit which are not yet the target of the integration process.

For example, when the present invention is applied to MPEG-DASH, the delivery control unit 130 repeatedly generates an HTTP response message including the media segment (or a movie fragment which is a part of the media segment). In this case, the delivery control unit 130 may add information (integration process timing information) indicating that the integration process is executed to the header portion of the HTTP response message and deliver the HTTP response message including the integration process timing information at each prescribed timing. Then, the segment conversion unit 240 may execute the integration process at a timing at which the playing device receives the HTTP data including the timing information.

Since the HTTP response message stores the individual media segment, the delivery control unit can also add the segment conversion information added to the header portion of the media segment by the segment conversion information addition unit to the header portion of the HTTP response message rather than the header portion of the media segment in the third embodiment. For example, the delivery control unit can add the segment conversion information as a media type parameter in the Content-Type header. In the delivery device that adds the segment conversion information to the header portion of the HTTP response message to deliver the segment conversion information, it is possible to obtain the same advantageous effects as the delivery device 100a of the delivery system according to the third embodiment.

In the above description, the information indicating the timing of the integration process has been recorded in one of an independent command, the control information for live delivery, the header portion of the media segment, the metadata box, or the header portion of the HTTP response message to be announced.

Incidentally, the control information used to acquire and play the program video is information which is acquired periodically at the time of delivery start or during the delivery. The number of media segments to be delivered is generally large while the media segments are delivered merely several times. Therefore, the fact that the header portion of the media segment (or the metadata box) is normally monitored and whether there is the announcement of the execution of the integration process is normally determined becomes a processing load on the production apparatus at the time of reception. In particular, the foregoing determination process is not necessary when it is apparent not to execute the announcement of the execution of the integration process by the media segment in advance, during each delivery period, or for each media segment by the delivery service.

As means for avoiding a situation in which such an inefficient process occurs, an identifier indicating that the media segment has description of announcement of the execution of the integration process (whether the integration process is executed can be determined by the description) during each delivery period described in the control information or for each media segment may be described in the control information, and the determination process may be partially omitted by the identifier. That is, only when the identifier described in the control information indicates that the media segment has the description of the announcement of the execution of the integration process, the description of the announcement of the execution of the integration process is read from the header portion or the metadata box of the media segment. By doing so, it is possible to improve the processing efficiency of the entire delivery.

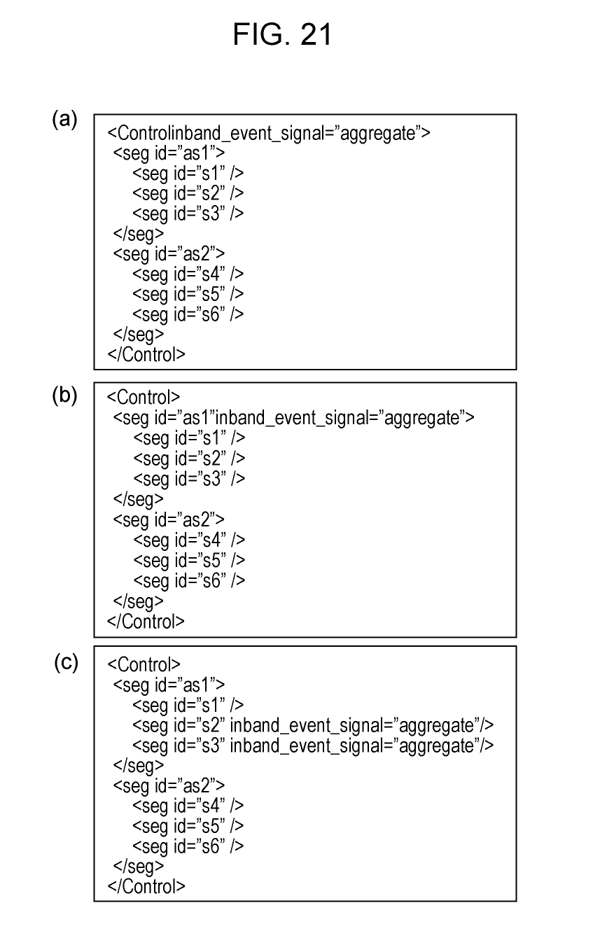

FIG. 21 illustrates an example of the control information including the foregoing identifier. In FIG. 21, “inband_event_signal=“aggregate”” is an identifier indicating that the media segment has the description of the announcement of the execution of the integration process. FIG. 21(a) illustrates an example in which, in the entire control information, the media segments (that is, all of the segments s1 to s6) have the description of the announcement of the execution of the integration process. FIG. 21(b) illustrates an example in which, in a group of the hierarchically written media segments, the media segments (that is, the segments s1 to s3) belonging to the group have the description of the announcement of the execution of the integration process. FIG. 21(c) illustrates an example in which, in the individual media segments, the media segments (that is, the segments s2 and s3) have the description of the announcement of the execution of the integration process.

In an embodiment in which the playing device or the secondary delivery device, that is, the reception-side apparatus, does not execute the segment conversion process and, as described in Supplement 3, the delivery device or the primary delivery device, that is, a delivery-side apparatus, executes the segment conversion process, the description of the announcement of the execution of the integration process stored in the header portion or the metadata box of the media segment described above and the foregoing identifier included in the control information indicating the presence of the description of the announcement can also be realized as announcement that the delivery-side apparatus notifies a reception-side apparatus of the execution of the integration process at the execution timing and an identifier indicating whether the media segment has the description of the announcement.

As described as in Supplement 3, in an embodiment in which the delivery device or the primary delivery device, that is, a delivery-side apparatus, executes the segment conversion process and the control information conversion process for the delivery, an object of the embodiment is to provide a reception-side apparatus to a special playing service such as time shift delivery and time shift playing of a delivered and played-back scene executed retroactively. Thus, the playing device or the secondary delivery device, that is, the reception-side apparatus, using no special playing service may make a choice not to update the control information of the reception-side apparatus even when receiving the foregoing announcement from the delivery-side apparatus. Thus, the reception-side apparatus which does not use a part of the special playing service can omit the control information update process. As a result, the reception-side apparatus which does not use the special playing service retains control information different from that of a reception-side apparatus using the special playing service.

From the viewpoint of the delivery-side apparatus, it is preferable to manage a difference in the control information retained in the reception-side apparatus. That is, when the control information is updated to add the foregoing special playing service, the reception-side apparatus can freely select whether to update the control information (the reception-side apparatus is permitted to make a choice). On the other hand, when control information is updated to switch a current delivery device to another apparatus due to a change in a communication environment (to change the address of a delivery source server), all of the reception-side apparatuses are required to update the control information so that the control information of all of the reception-side apparatuses is the same. In this case, the delivery-side apparatus executes subsequent delivery on the assumption that the control information of the reception-side apparatus is updated. The reception-side apparatus which does not update the control information may not continuously receive the media segments. For this reason, the delivery-side apparatus executing the foregoing announcement may be configured to deliver information indicating whether to permit the reception-side apparatus not to update the control information among with the foregoing announcement.

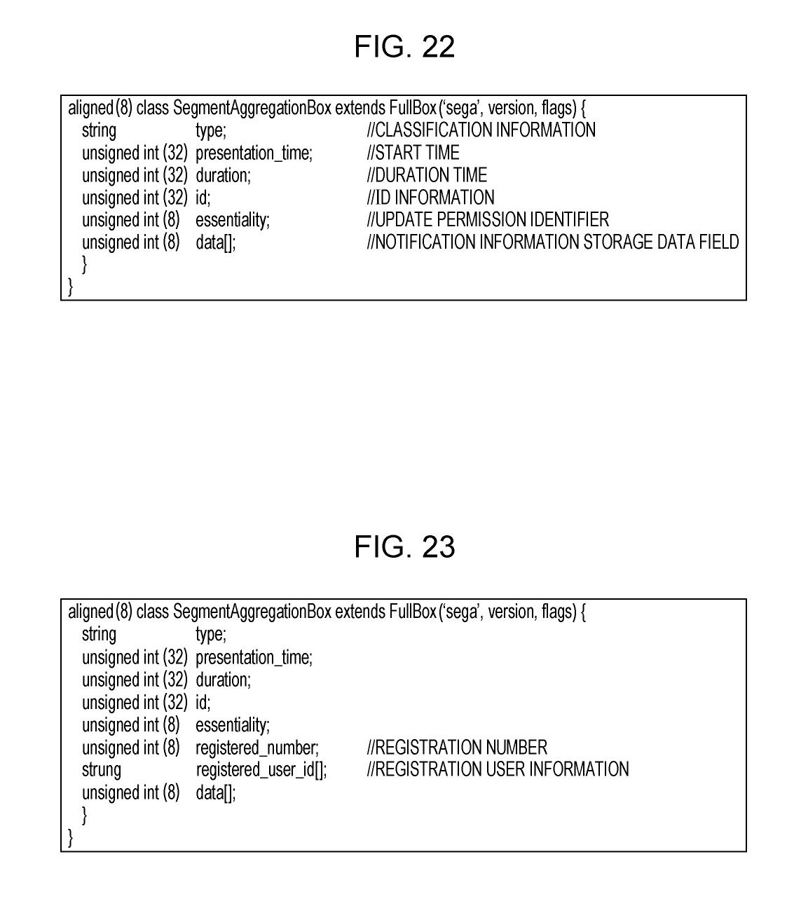

FIG. 22 illustrates a description example in which an identifier indicating whether to permit the foregoing reception-side apparatus not to update the control information is inserted into the metadata box Segment Aggregation Box used for announcement of the segment conversion information. In FIG. 22, “essentiality” corresponds to this identifier. Here, “essentiality” is assumed to have binary values (true and false binary values) of 0 and 1. Here, 0 (false) indicates the permission of non-execution of the update and 1 (true) indicates prohibition of non-execution of the update (that is, the reception-side apparatus essentially executes the update). Of course, a general metadata box Event Message Box used for announcement of various events including segment integration may be defined and the Event Message Box may include the foregoing identifier “essentiality.”

In FIG. 22, “type” indicates classification of the metadata box, that is, classification of announcement information announced by the metadata box. In the case of Segment Aggregation Box, for example, whether one of agg, seq_num, agg_s/e_frag, agg_en_frag, agg_st_frag, and agg_rest_num described in the third embodiment is stored is described as the classification of a delivery format. Alternatively, information indicating a use purpose such as dedicated time shift or time shift+trickplaying may be described as text information. The values which “type” can have be defined in advance and can also be described as numerical indexes such as 1, 2, and 3.

Further, in consideration of the general metadata box Event Message Box, information such as “Segment Concatenation” (segment integration) and “Server Change” (server switch) is described as text information or numeral index in “type.”

Here, “data [ ]” is a data field for actually storing various kinds of announcement information transmitted with the metadata box. Further, a data format of “data [ ]” is uniquely determined by the value of “type.” For example, in the case of Segment Aggregation Box, the various kinds of segment conversion information described in the third embodiment and Supplement 6 are described in this field. The trigger flag agg trigger described in Supplement 6 is also described in this field.

When permission or non-permission of the update of the control information is uniquely determined by the details of the announcement, the information indicating the classification of announcement details may be included and may also serve as information of the permission. That is, in the case of FIG. 22, the metadata box may not include “essentiality” and “type” may also serve as permission information regarding non-execution of the update of the control information.

The foregoing announcement is also assumed to be provided as a value-added service which only some of the reception-side apparatuses receive. In this case, announcement (announcement that the segment integration process is executed on the delivery side) of the segment integration may be issued only to specific reception-side apparatuses. That is, only some of the reception-side apparatuses receiving the value-added service, that is, users treating with the value-added service, receive the corresponding updated control information and enjoy the value-added service. Even in this case, the reception-side apparatuses using the service and the reception-side apparatuses not using the service retain different control information.

From the viewpoint of the delivery-side apparatus, of course, it is assumed that a difference in the control information retained in the reception-side apparatus can be managed. That is, it is assumed that the delivery-side apparatus can manage an operation process of updating the control information for the specific users and not updating the control information for the remaining users. Such a management is realized by changing the announcement details for each reception-side apparatus (the announcement is not originally delivered to the reception-side apparatus incapable of receiving the announcement) or by describing receivable information regarding a delivery destination (the reception-side apparatus) in the announcement. A description example of the latter is illustrated in FIG. 23.

FIG. 23 illustrates the description example in which information regarding the delivery destination capable of receiving the announcement is described in the metadata box Segment Aggregation Box. In FIG. 23, “registered_number” and “registered_user_id [ ]” correspond to the information regarding the delivery destination. The registration number of registered delivery destinations is described in “registered_number” and user ID information (for example, a receiver IP address) of each delivery destination is described in “registered_user_id [ ]” (as a list corresponding to the registration number). Of course, a general metadata box Event Message Box for announcement of an event may be defined and the Event Message Box may include “registered_number” and “registered_user_id [ ].” Further, the same description as the description of “type,” “data [ ],” “essentiality,” and the like made in FIG. 22 is also applied to FIG. 23.

An embodiment can also be assumed in which each segment does not have an event announcement metadata box and an event announcement data stream collecting the metadata boxes of the segments is separately defined and is delivered separately from the segments (for example, multiplexed with a media stream of the segments). In this case, a configuration can also be realized in which the event announcement data stream has a header portion including the foregoing permission information “essentiality” and the delivery destination information “registered_number” and “registered_user_id [ ],” and the permission information and the delivery destination information are applied to each announcement event included in a data stream.

The foregoing permission information “essentiality” can also be described in the control information, as described in FIG. 21, in which the identifier indicating whether the announcement of the event (the execution of the integration process in the case of FIG. 21) is included in the media segment and can be combined with the permission information “essentiality” described in the metadata box of each segment. Alternatively, the foregoing permission information “essentiality” and the delivery destination information “registered_number” and “registered_user_id [ ]” can also be described in the same control information and can be combined with the information described in the metadata box of each segment to be used.

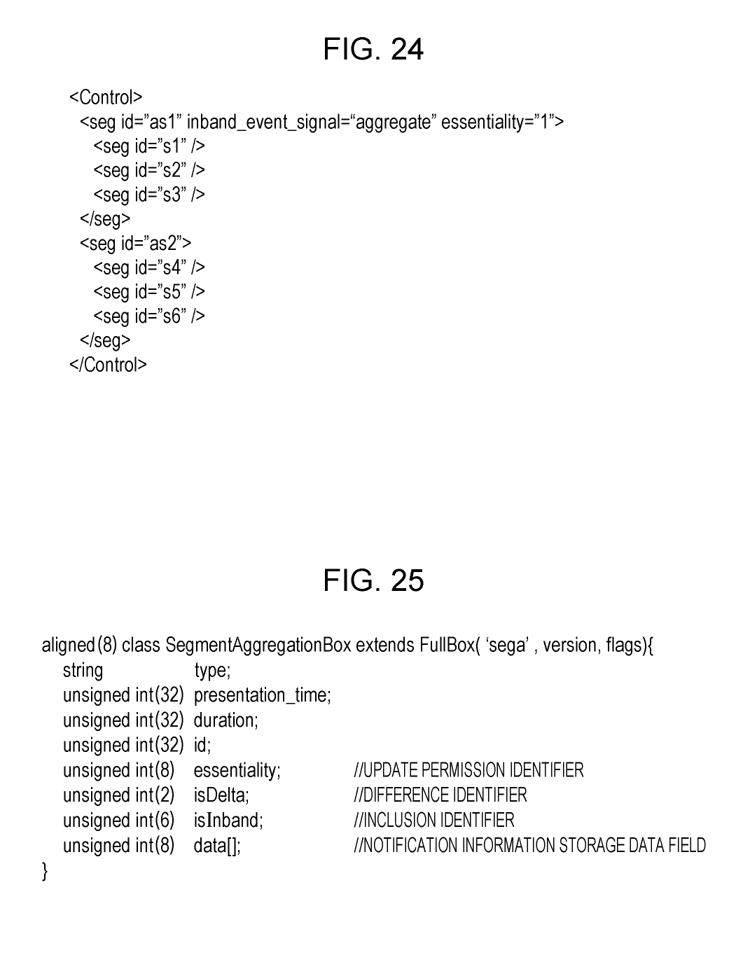

FIG. 24 illustrates a description example in which the permission information “essentiality” is added to FIG. 21(b).

In FIG. 24, “essentiality=“1”,” that is, prohibition of the non-execution of an event (prohibition of the non-execution of the integration process in the case of FIG. 24) is clearly expressed for a group as1 of the media segments. In this case, the non-execution of an event is interpreted to be prohibited for all of the segments s1, s2, and s3 included in the segment group as1. Accordingly, it is not necessary to describe “essentiality” in the metadata box of the media segment data of the segments s1, s2, and s3 (or the description is neglected).

When “essentiality=“0”” is clearly expressed for the group as1 of the media segments, permission of the non-execution of an event is interpreted to be a default value for all of the segments s1, s2, and s3 included in the segment group as1. When “essentiality” is not described in the metadata box of the media segment data of the segments s1, s2, and s3, the segments are interpreted to have the default value, that is, the segments are permitted not to execute the event. On the other hand, when “essentiality” is described (“essentiality=“1”” is described) only in the metadata box of the media segment s3, only the event of the segment s3 is interpreted to be prohibited from not being executed.

Thus, since the permission information “essentiality=“1”” described in the control information is preferred, events to be announced can be appropriately divided by classification. By collectively specifying the events of the prohibition of the non-execution in the control information, the process of determining the execution or the non-execution is simplified. In the example of FIG. 24, only one pair of classification “inband_event_signal” and permission information “essentiality” of the event is described, but a plurality of events can also be described as a list and “essentiality” can be described for each event.

In the foregoing description, the identifier “essentiality” has been set to have the binary values of 0 and 1, but can also have multiple values. For example, the identifier can have the following values:

0: permission of non-execution of an event;

1: prohibition of non-execution of an event, where the permission of the non-execution and announcement to an event issuing source are not necessary when a terminal does not correspond to the event;

2: prohibition of non-execution of an event, where the permission of the non-execution and announcement to an event issuing source are necessary when a terminal does not correspond to the event;

3: prohibition of non-execution of an event and announcement to an event issuing source by stopping the execution when a terminal does not correspond to an event so that the event is inexecutable. As described above, an event for announcement of the conversion from the segments for live delivery to the segment for recording and playing is exemplified herein. The segment for recording and playing is used for the special playing service or the like. Of the 4 values “essentiality,” “essentiality=“0”” indicates that whether a reception-side apparatus receives any event and executes special playing can be selected, as described above. Here, “essentiality=“1”” specifies that a reception-side apparatus which does not correspond to the special playing is permitted and an event is necessarily interpreted for a reception-side apparatus which corresponds to the special playing. Further, “essentiality=“2”” specifies that a reception-side apparatus which does not correspond to the same special playing is permitted and an event is necessarily interpreted for a reception-side apparatus which corresponds to the special playing. Moreover, the reception-side apparatus which does not correspond to the special playing essentially responses to an event issuing source and a delivery state can be comprehended in a delivery source. Furthermore, “essentiality=“3”” specifies that a reception-side apparatus which does not correspond to the special playing is explicitly prohibited.

### (Supplement 6-1)

When the control information conversion process is executed, the control information conversion process is executed on the entire control information in some cases and is limited to a part of the control information in some cases. As described in Supplement 3, in the case in which the process of converting the media segments and the control information is executed sequentially in accordance with the live delivery on the delivery side, the description of the lively delivered media segments S is deleted in the control information and the description of the media segment AS for recording and delivery is added (replacement of the description of the media segments S with the media segment AS) in the control information whenever a predetermined number of media segments S is lively delivered, but the other description details are not changed. In the case in which both of the processes of converting the segments and the control information are executed on the delivery side, as described in Supplement 3, the converted control information is delivered to a reception-side apparatus at each time. Therefore, when the size of the control information at the time of the delivery increases, the size of the control information may not be neglected. At this time, when the description details of the control information are not mostly changed, it is apparently redundant repeatedly transmit the control information of which the description details are not changed and it is inefficient in terms of data transmission efficiency.

For this reason, it can be considered that a difference in the control information is obtained and only the difference information is transmitted as difference control information.

For example, in the case of Supplement 3, the difference control information is configured by combining positional information indicating at which position the media segment S to be deleted is located among the media segments in the control information and a command “delete” indicating the deletion. Likewise, the difference control information is configured by combining component description information of the media segment AS to be added, positional information indicating at which position the media segment is added, and a command “add” indicating the addition. Alternatively, the difference control information is configured by combining component description information of the media segment AS, which is information indicating where the media segments to be replaced with one media segment AS are located among the media segments S, positional information indicating the positions of the media segments, and a command “replace” indicating the replacement. The difference control information with such a description format is referred to as structural difference control information since the difference control information depends on the structure of the control information.

Alternatively, in the case of Supplement 3, the difference control information can also be described such that the control information is comprehended as one text, the description of the media segments S located from a certain line to a certain line is deleted, and the description of the media segment AS located in a certain line is added. The difference control information with such a description format is referred to as textual difference control information.

When the segment conversion information added to the control information is handled as independent information separate from the control information in the first embodiment, the segment conversion information can be comprehended as difference control information used for update of the control information (and segment conversion information). The segment conversion information added to the header portion of the media segment in the third embodiment and the segment conversion information stored in the metadata box Segment Aggregation Box of the header portion of the media segment in Supplement 6 are examples of the difference control information. That is, even in the case in which the segment conversion process is executed on the delivery side, the segment conversion information is assumed to be transmitted as the difference control information used for the update of the control information to the delivery side. The segment conversion information is interpreted commonly on the delivery side and the reception side so that the control information can be converted and updated. The difference control information with such a description format is referred to as analytic difference control information.

In the case of Supplement 3, originally, when the delivery-side apparatus executes both of the media segment conversion process and the control information conversion process and the reception-side apparatus receives the announcement (the metadata box Segment Aggregation Box of the media segment for announcement of the segment conversion) described in Supplement 6, the reception-side apparatus newly makes a request for the control information and newly obtains the media segment based on the new control information. At this time, as described above, the delivery system including the delivery-side apparatus and the reception-side apparatus is a system capable of delivering the difference control information. When the control information can be updated based on the difference control information in the reception-side apparatus (when new control information can be formed from the original control information and the difference control information), an identifier “isDelta” indicating whether the delivered control information is “complete” control information or “delta” control information is added to the announcement (the metadata box Segment Aggregation Box of the media segment for announcement of the segment conversion) to identify the delivered control information. When “isDelta” is 0, the control information is assumed to be the “complete” control information. When “isDelta” is 1, the control information is assumed to be the “delta” control information.

The difference control information is data in which a changed portion of the control information is collected and which has a small size. Thus, it can also be assumed that the fact that the difference control information is present in the header or the metadata box of the media segment is announced, a request is made and the difference control information is obtained after reception of the announcement, and the difference control information is also stored in the header or the metadata box to be transmitted along with the data of the segment. In this case, an identifier “isInband” indicating whether the difference control information is separately delivered (“excluded”) or the difference control information is included (“included”) is added to the header or the metadata box and whether the difference control information is included is identified. When “isInband” is 0, the difference control information is separately delivered (“excluded”). When “isInband” is 1, the difference control information is included and delivered (“included”).

FIG. 25 illustrates an example of the metadata box Segment Aggregation Box including a difference identifier “isDelta” and an inclusion identifier “isInband.” The delivered control information is summarized as follows whether the control information is complete or delta information and is the inclusion information or not.

isDelta=“0” and isInband=“0”: “complete” control information and control information is obtained and separately delivered (“excluded”) after reception of segment isDelta=“0” and isInband=“1”: “complete” control information and control information is included in segment data and is delivered (“included”)
isDelta=“1” and isInband=“0”: “delta” control information and control information is obtained and separately delivered (“excluded”) after reception of segment isDelta=“1” and isInband=“1”:“delta” control information and control information is included in segment data and is delivered (“included”)

At this time, information indicating the control information for the difference information to which the delivered difference control information corresponds may be attached. As information indicating target control information, for example, id information of the control information or delivery time information indicating a time at which the control information is delivered can be used. A delivery time of the difference control information is assumed to be added to the control information updated based on the difference control information.

As a special case in which the difference control information is stored in the header or the metadata box of the media segment to be delivered, a case can be considered in which the difference control information to be delivered is further divided into a plurality of pieces of partial difference control information and the plurality of pieces of partial difference control information are stored in the plurality of media segments to be delivered in a subdivision manner. The reception-side apparatus forms the difference control information from the plurality of pieces of partial difference control information obtained from the headers or the metadata boxes of the plurality of media segments and updates the control information. At this time, the reception-side apparatus can form the difference control information and update the control information by including serial numbers of the partial difference control information and the number of divisions in the header or the metadata box and transmitting the serial numbers of the partial difference control information and the number of divisions along with the information used to identify the difference control information, for example, the ID information. At this time, a delivery time of the original difference control information is added to the delivery time of the divided partial difference control information.

A delivery example by the partial difference control information will be described as follows with reference to FIG. 25. A value including the number of divisions, for example, a value “abcde-5,” is described in the ID information “id.” Here, “5” indicates the number of divisions and this ID value can be supplied commonly to all of the partial difference control information. A value of the serial number, that is, “1” to “5,” is described in the inclusion identifier “isInband.” Therefore, “isInband” in FIG. 25 is a 6-bit variable that has values of 0 to 63. That is, the inclusion identifier “isInband” is an identifier that indicates separate transmission when the value is “0” and indicates the inclusion and serial number when the value is “1” to “63.”

When the size of the control information is not large, the control information can also be stored in the header or the metadata box of the media segment to be delivered. In this case, in the same way, it can, of course, be considered that the control information is divided into a plurality of pieces of partial control information and the plurality of pieces of partial control information are stored in the plurality of segments to be delivered in the subdivision manner. The reception-side apparatus forms the control information from the plurality of partial control information obtained from the plurality of media segments. At this time, as described above, the control information can be formed by including and transmitting the serial numbers of the partial control information and the number of divisions in the header or the metadata box along with the information used to identify the control information, for example, the ID information. Likewise, a delivery time of the original difference control information is assumed to be added to the delivery time of the divided partial difference control information.

As described above, there are a plurality of different description formats (“structural,” “textual,” and “analytic”) of the difference control information. In a system capable of using the plurality of different description formats of the difference control information, format information indicating the description format of the difference control information may be added to the metadata box used for the announcement along with the identifier identifying the complete or delta information so that the delivered difference control information can be identified. Of course, identification information serving as the identifier indicating that the complete or delta information and the format information indicating the difference format may be defined and added to the foregoing box.

This case will be described as follows with reference to FIG. 25. It is assumed that the difference identifier “isDelta” has 4 values of “0” to “3,” “1” indicates “structural” difference control information, “2” indicates “textual” difference control information, and “3” indicates “analytic” difference control information. Further, “0” indicates the “complete” control information. Therefore, “isDelta” in FIG. 25 is a 2-bit variable that can have values of 0 to 3. That is, the difference identifier “isDelta” is an identifier that has a value of “0” indicating the complete control information and values of “1” to “3” indicating the difference control information and the description formats.

Whether the control information is the complete or delta information can also be comprehended as one of the classifications of the control information. That is, classification information of the control information can also serve as the difference identifier. Likewise, whether the control information or the difference control information is included in the header or the metadata box of the media segment or is separately delivered can also be comprehended as one of the classification of the control information. That is, the classification information of the control information can also serve as the inclusion identifier. In other words, the classification information used to identify all kinds of information, that is, identify which event the control information indicates, whether the control information is the complete or delta information, and whether the control information is included or separately transmitted, can also be defined and attached to the control information to be used.

Whether the difference control information (or the control information) is included or not can also be detected, for example, when the size of the metadata box is known. That is, size information regarding the metadata box or the like can also serve as the inclusion identifier. The inclusion identifier may be included in the data field data [ ] to be announced. In particular, when whether the control information is the complete or delta information is announced as the classification information of the control information, the inclusion identifier may be included in the data field data [ ] and announced.

As described in Supplement 6, when the difference control information is delivered, a case in which the reception-side apparatus can make a choice to update the control information can be applied. In this case, an identifier “essentiality” indicating whether the reception-side apparatus is permitted not to execute the update of the control information is added to the metadata box Segment Aggregation Box.

However, unlike the case in which the entire control information is received and updated in Supplement 6, it is necessary to manage an update history in the update of the difference control information. That is, this is because when the non-execution of the update by the reception-side apparatus is permitted, there is a probability of new difference control information not being processible by the control information which is the target of the difference control information due to the control information on which the update is previously executed or the control information on which the update is skipped by the difference control information.

As a simple method of resolving the defect, there is means for describing the identification information of the control information which is the target of the difference control information in the metadata box Segment Aggregation Box and obtaining the entire control information again when the control information already retained by the reception-side apparatus does not match the identification information described in the metadata box. As the identification information of the control information, id information or delivery time information of the control information (difference control information) is used. At this time, when there are the plurality of pieces of control information which are update targets of the difference control information, each piece of identification information of the control information is listed and described. For example, when the initial control information is delivered at 0 o'clock and the difference control information is delivered at 1 o'clock, 2 o'clock, and 3 o'clock and when the difference control information delivered at 3 o'clock can be applied to the control information of 0 o'clock, the control information including the control information of 0 o'clock+the difference control information of 1 o'clock, or the control information including the control information of 0 o'clock+the difference control information of 1 o'clock+the difference control information of 2 o'clock, the delivery times 0 o'clock, 1 o'clock, and 2 o'clock are listed and described as the identification information attached to the difference control information of 3 o'clock.

Here, as easily supposed from the foregoing example, when there is the control information including the control information of 0 o'clock+the difference control information of 2 o'clock excluding the difference control information of 1 o'clock in the foregoing example, the control information may not be managed. Alternatively, when the identification information is expressed as combinations of 0 o'clock, 0 o'clock+1 o'clock, 0 o'clock+1 o'clock+2 o'clock, and 0 o'clock+2 o'clock, the management can be executed. However, all of the combinations have to be considered, and thus when the number of updates (the number of pieces of difference control information) increases, the combinations are not realistic. Version management of the control information is necessary likewise even in the reception-side apparatus, and thus this process is not suitable.

Thus, a feasible management method is as follows.

The reception-side apparatus manages the version of the control information based on a register counter of 0 or 1 indicating whether to update by applying the delivery time of the control information (the difference control information) and the previously received difference control information.

When the complete control information is received, the register counter is reset to 0.

After the difference control information is received and whether to update the control information is determined applying the difference control information, the register counter is shifted to a side larger by 1 stage. The determination of whether to update the control information will be described below. That is, the value of register 1 is shifted to register 2 and the value of register 2 is shifted to register 3. Thereafter, when the control information is updated applying the received difference control information, the counter of register 1 is set to 0. When the control information is not updated, the counter of register 1 is set to 1.

When the delivery-side apparatus transmits the difference control information and there is the previous requisite difference control information to apply the difference control information, a mask of which a sequence position corresponding to the difference control information is 1 is described in the metadata box along with the delivery time of the corresponding control information and is transmitted to the reception-side apparatus. That is, when the difference control information located previously by two pieces of information ahead of the control information identified by delivery time T is requisite, a mask of 01 is transmitted.

Then, the reception-side apparatus takes a logical product of the received mask and the column of the register counter value. When the value of the product is 1, the necessary difference control information is determined not to be included in the current control information and the new complete control information is requested. However, when the identifier “essentiality” indicating the permission of the non-execution of the update is not up, the complete control information is not requested and non-execution of the application to the register is registered to allow the process to continue. When the value of the product is 0, whether to update control information is selected according to the value of the identifier “essentiality.” After the registration in the register, the process continues.

For example, when the difference control information located previously by one piece or two pieces of information ahead of the control information identified by the delivery time T is applied, the first and second register counters are registered to 00. Accordingly, the logical product with the foregoing mask of 01 becomes 0 and the difference control information is applied without change. When the difference control information located previously by one piece of information is not applied the difference control information located previously by two pieces of information is applied, the first and second register counters are registered to 10. The logical product with the foregoing mask of 01 becomes 0 and the difference control information is applied likewise without change. On the other hand, when the difference control information located previously by one piece of information is applied and the difference control information located previously by two pieces of information is not applied, the first and second register counters are registered to 01. Since the logical product with the foregoing mask of 01 becomes 1 and the control information to which the necessary difference control information is not applied is known, the complete control information is requested again.

When the number of register counters exceeds a manageable number, the complete control information is requested. Thus, the version of the control information can be managed.

Alternatively, in order to resolve the foregoing problem, the defect may be resolved by imposing given limitation on management of the control information. For example, the following condition is added. When there is omission in the middle, the new difference control information can be applied only in the case in which there is no influence on the subsequent update. In the foregoing case, the difference control information of 3 o'clock can be applied even in the combination of 0 o'clock+2 o'clock. Only when it is not necessary to distinguish 0 o'clock+1 o'clock+2 o'clock from 0 o'clock+2 o'clock, the permission is given.

When the difference control information is delivered, in particular, the difference control information is stored in the metadata box and is delivered simultaneously with the segment, only the component of the control information to be updated is stored in the difference control information, and thus the update classification of the control information can be known from the difference control information. Therefore, instead of the storage of the classification information “type” in the metadata box, the execution/non-execution of the update can also be selected by seeing the component information of the difference control information. That is, the classification of the component which is to be updated and is included in the difference control information also serves as the classification information.

### (Supplement 7)

In each of the foregoing embodiments, the case has been described in which the media segments for live delivery of an aggregate generated with the live camera are integrated into the single media segment for recording and playing. In contrast, each apparatus executing VOD delivery can also be configured as follows in order to execute the VOD delivery with small delay (in this case, delay from a VOD delivery request) from a delivery device, a secondary delivery device, or a playing device recording a media segment for recording and playing (accumulation) (of which accumulation efficiency is high). That is, each apparatus executing the VOD delivery can also be configured to add information used for time division of the single already recorded media segment for recording and playing (accumulation) into a plurality of low-delay VOD delivery media segments with a shorter time length.

Specifically, the control information update unit may add a div_seg_dur attribute (an attribute indicating a time length of each segment after the time division) to the Control component in the control information. For example, a tag text string <Control seg_dur=“30 s”> in the control information may be updated to a tag text string <Control seg_dur=“30 s” div_seg_dur=“10 s”>.

Based on the updated control information, the segment conversion unit may divide one accumulation media segment (in the foregoing example, one media segment with a time length of 30 seconds) with a long time length into a plurality of low delay VOD delivery media segments (in the foregoing example, 3 media segments with a time length of 10 seconds) with a shorter time length in a time division manner.

Then, the control information conversion unit may update the control information transmitted from the delivery device to control information including a seg component regarding each media segment with a shorter time length.

### (Supplement 8)

In all of the embodiments, the functions and the operations of the delivery device, the secondary delivery device, and the playing device have been described using the media segments with the short time length as the media segments for live delivery and using the media segment with the long time length as the media segment for recording and playing or VOD delivery. However, it is apparent that the time length and the delivery use purpose may not be matched one to one. For example, it is permissible to comprehend a media segment with a short time length as a media segment for live delivery of considerably low delay and comprehend a media segment with a long time length as general media segment for live delivery for which delay is allowable. A configuration in which the media segment for live delivery of low delay is converted into the general media segment for live delivery is also included in the scope of the present invention of the present specification.

### Realization Example by Software

Finally, blocks of the delivery device, the primary delivery device, the secondary delivery device, and the playing device, particularly, blocks of the playing unit 220, the control information conversion unit 230 (320), the segment conversion unit 240 (330), and the delivery control unit 350, may be realized by logic circuits formed on an integrated circuit (IC chip) in a hardware manner or may be realized in a software manner using a central processing unit (CPU).

In the latter case, the delivery device and the playing device each include a CPU that executes a command of a program realizing each function, a read-only memory (ROM) that stores the program, a random access memory (RAM) that loads the program, and a storage device (recording medium) such as a memory that stores the program and various kinds of data. An object of the present invention can also be achieved by providing each of the foregoing delivery device and playing device with a recording medium that records a program code (executable program, an intermediate code program, or a source program) of a control program of each of the delivery device and the playing device so that a computer can read the program code and causing the computer (or a CPU or an MPU) to read and execute the program code recorded on the recording medium.

As the recording medium, non-transitory tangible medium, for example, a kind of tape such as a magnetic tape or a cassette tape, a kind of disc including a magnetic disk such as a floppy (registered trademark) disk/hard disk or an optical disc such as a CD-ROM/MO/MD/DVD/CD-R, a kind of card such as an IC card (including a memory card)/optical card, a kind of semiconductor memory such as a mask ROM/EPROM/EEPROM (registered trademark)/flash ROM, or a kind of logic circuit such as a programmable logic device (PLD) or a field programmable gate array (FPGA) can be used.

Each of the foregoing delivery device and playing device may be configured to be connected to a communication network and the foregoing program code may be supplied via the communication network. The communication network may transmit the program code and the present invention is not particularly limited thereto. For example, the Internet, an intranet, an extranet, a LAN, an ISDN, a VAN, a CATV communication network, a virtual private network, a telephone circuit network, a mobile communication network, a satellite communication network, or the like can be used. A transmission medium forming the communication network may also be a medium capable of transmitting the program code and the present invention is not limited to a specific configuration or a specific kind of medium. For example, the transmission medium can also be used in a wired line such as IEEE 1394, a USB, a power line carrier, a cable TV circuit, a telephone line, or an Asymmetric Digital Subscriber Line (ADSL) circuit or can also be used in a wireless line such as an infrared ray such as IrDA or remote control, Bluetooth (registered trademark), IEEE 802.11 wireless, High Date Rate (HDR), Near Field Communication (NFC), Digital Living Network Alliance (DLNA), a portable telephone network, a satellite circuit, a terrestrial digital network. The present invention can also be realized in a form of computer data signals in which the program code is realized through electronic transmission and which is embedded in carrier waves.

### INDUSTRIAL APPLICABILITY

The present invention can be appropriately used for a delivery server delivering content, a player playing content, a television receiver, a radio receiver, a game apparatus, and the like.

### REFERENCE SIGNS LIST

100, 100a DELIVERY DEVICE
100′, 100b PRIMARY DELIVERY DEVICE
110 STORAGE UNIT
120 CONTROL INFORMATION UPDATE UNIT
130 DELIVERY CONTROL UNIT
140 TRANSMISSION UNIT
140′ COMMUNICATION UNIT
150 SEGMENT GENERATION UNIT
200, 200′PLAYING DEVICE
210 RECEPTION UNIT (ACQUISITION MEANS)
210′ COMMUNICATION UNIT
220 PLAYING UNIT (PLAYING MEANS)
230 CONTROL INFORMATION CONVERSION UNIT (SECOND CONVERSION MEANS)
240 SEGMENT CONVERSION UNIT (FIRST CONVERSION MEANS)
250 STORAGE UNIT
300, 300a SECONDARY DELIVERY DEVICE
310 COMMUNICATION UNIT
320 CONTROL INFORMATION CONVERSION UNIT (SECOND CONVERSION MEANS)
330 SEGMENT CONVERSION UNIT (FIRST CONVERSION MEANS)
340 STORAGE UNIT
350 DELIVERY CONTROL UNIT (FIRST DELIVERY MEANS, SECOND DELIVERY MEANS)

1-24. (canceled)

25. A delivery apparatus comprising:
a delivery unit that delivers a plurality of media segments which are data divided from content in a time division manner and metadata for acquiring and playing the content,
wherein when the media segment includes an event announcement description, the delivery unit delivers the metadata which includes an identifier indicating that the media segment includes the event announcement description.

26. A delivery method of delivering a plurality of media segments which are data divided from content in a time division manner and metadata for acquiring and playing the content, the delivery method comprising:
a first delivery step of delivering the media segments; and
a second delivery step of delivering the metadata,
wherein when the media segment includes an event announcement description, the metadata which includes an identifier indicating that the media segment includes the event announcement description is delivered in the second delivery step.

27. A playing apparatus receiving and playing content, comprising:
a reception unit that receives a plurality of media segments which are data divided from the content in a time division manner and metadata for acquiring and playing the content,
wherein when the media segment includes an event announcement description, the reception unit receives the metadata which includes an identifier indicating that the media segment includes the event announcement description, and
wherein for the media segment that does not indicate that the metadata includes the event announcement description, a process relevant to the event announcement description is omitted.

28. A playing method of receiving and playing content, comprising:
a first reception step of receiving metadata for acquiring and playing the content;
a second reception step of receiving a plurality of media segments which are data divided from the content in a time division manner; and
a processing step of processing the media segments,
wherein when the media segment includes an event announcement description, the metadata includes an identifier indicating that the media segment includes the event announcement description, and
wherein for the media segment that does not indicate that the metadata includes the event announcement description, a process relevant to the event announcement description is omitted in the processing step.
